(19) United States
(12) Patent Application Publication
(10) Pub. No.: US 2017/0174981 A1
(43) Pub. Date: Jun. 22, 2017

(54) DEGRADABLE COMPONENTS

(71) Applicant: Schlumberger Technology Corporation, Sugar Land, TX (US)

(72) Inventors: Indranil Roy, Sugar Land, TX (US); Gregoire JACOB, Houston, TX (US); Rashmi Bhavsar, Houston, TX (US)

(21) Appl. No.: 15/300,165

(22) PCT Filed: Mar. 30, 2015
(86) PCT No.: PCT/US2015/023242

§ 371 Date: Sep. 28, 2016

Related U.S. Application Data
(60) Provisional application No. 61/973,009, filed on Mar. 31, 2014.
(60) Provisional application No. 62/084,961, filed on Nov. 26, 2014.

(51) Int. Cl. C09K 8/66; C22C 45/08; C09K 8/62; C09K 8/02; C09K 8/42

(52) U.S. Cl. CPC C09K 8/665; C09K 8/02; C09K 8/42; C09K 8/62; C22C 45/08

(57) ABSTRACT

A powder of particles can include an aluminum alloy where the aluminum alloy is at least approximately eighty percent by weight of the powder; and one or more metals selected from a group consisting of alkali metals, alkaline earth metals, and basic metals having an atomic number equal to or greater than 31, where the one or more metals selected from the group total at least approximately two percent by weight of the powder; where each of the particles includes individual grains formed of a grain material that includes the aluminum alloy, where each of the particles includes grain boundary material that includes the one or more metals selected from the group, and where the grain boundary material bounds the individual grains.

### RELATED APPLICATION

This application claims the benefit of and priority to a U.S. Provisional Patent Application having Ser. No. 61/973,009, filed 31 Mar. 2014, and a U.S. Provisional Patent Application having Ser. No. 62/084,961, filed 26 Nov. 2014, each of which is incorporated by reference herein.

### BACKGROUND

Various types of materials are used in equipment, operations, etc. for exploration, development and production of resources from geologic environments. For example, equipment may be used in one or more of a sensing operation, a drilling operation, a cementing operation, a fracturing operation, a production operation, etc.

### SUMMARY

A powder of particles can include an aluminum alloy where the aluminum alloy is at least approximately eighty percent by weight of the powder; and one or more metals selected from a group consisting of alkali metals, alkaline earth metals, and basic metals having an atomic number equal to or greater than 31, where the one or more metals selected from the group total at least approximately two percent by weight of the powder; where each of the particles includes individual grains formed of a grain material that includes the aluminum alloy, where each of the particles includes grain boundary material that includes the one or more metals selected from the group, and where the grain boundary material bounds the individual grains. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIGS. 1 and 2 illustrate an example of a method and examples of equipment for fracturing a geologic environment;

FIG. 3 illustrates an example of equipment in various example operational states;

FIG. 4 illustrates an example of a method;

FIG. 5 illustrates an example of a system;

FIG. 6 illustrates an example of a micrograph of an example of a particle;

FIG. 7 illustrates an example of a micrograph of an example of a particle;

FIG. 8 illustrates an example of a micrograph of an example of a particle;

FIG. 9 illustrates an example of a plot of data associated with the particle of FIG. 8;

FIG. 10 illustrates an example of a plot of data associated with the particle of FIG. 8;

FIG. 11 illustrates an example of a micrograph of an example of a particle;

FIG. 12 illustrates an example of a micrograph of an example of a particle;

FIG. 13 illustrates an example of a plot of an example of a material;

FIG. 14 illustrates an example of a plot of a component parameter versus degradation time; and

FIG. 15 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As an example, a material or materials may be processed to form processed material. In such an example, the processed material may be machined, formed, etc. to produce a part or parts. As an example, a part may be a component or a portion of a component. A part may be included in equipment, which may be suitable for use in an environment such as, for example, a downhole environment. As an example, equipment may be drilling equipment, cementing equipment, fracturing equipment, sampling equipment, or other type of equipment. As an example, equipment may be borehole equipment. As an example, a tool may be a borehole tool, for example, suitable to perform a function or functions in a downhole environment in a borehole.

As to cementing equipment, such equipment may be used in one or more downhole cementing operations. As an example, cement may be placed adjacent to a liner. As an example, a liner may be a string of casing in which the top does not extend to the surface but instead is suspended from inside another casing string. As an example, a liner hanger may be used to attach or hang one or more liners from an internal wall of another casing string.

As an example, a method may include operating one or more components of a liner hanger system. As an example, a lower completion may be a portion of a well that is at least in part in a production zone or an injection zone. As an example, a liner hanger system may be implemented to perform one or more operations associated with a lower completion, for example, including setting one or more components of a lower completion, etc. As an example, a liner hanger system may anchor one or more components of a lower completion to a production casing string.

As an example, equipment may include one or more plugs, one or more seats that can receive a respective plug, etc. In such an example, it may be desirable that a plug and/or a seat have properties suited for one or more operation or operations. Properties may include mechanical properties and may include one or more other types of properties (e.g., chemical, electrical, etc.). As an example, it may be desirable that a plug and/or a seat degrade. For example, a plug and/or a seat may be manufactured with properties such that the plug and/or the seat degrade when exposed to one or more conditions. In such an example, where the plug acts to block a passage, upon degradation, the passage may become unblocked. As an example, a component (e.g., a plug, a seat, etc.) may degrade in a manner that facilitates one or more operations. As an example, a component or a portion of a component may degrade in stages. For example, consider a plug that degrades from a first size to a second smaller size. In such an example, the second smaller size may allow the plug to move (e.g., from a first seat to a second seat, etc.). As an example, a plug tool may be a degradable tool. As an example, a plug tool may be degradable in part. For example, consider a plug tool with a degradable seat or degradable seats. In such an example, a plug may be seated in a degradable seat that upon degradation of the seat, the plug may pass through the seat (e.g., become unplugged with respect to that seat). As an example, a system can include a plug tool that is degradable at least in part and can also include one or more degradable plugs (e.g., balls, cylinders, etc.).

As an example, at least a portion of a borehole tool may be broken via interaction with a tool where at least some of resulting pieces are degradable. For example, a tool may apply force (e.g., drilling force or other force) to a plug, a plug tool, etc. such that the applied forces causes breaking into pieces of at least a portion of the plug, at least a portion of the plug tool, etc. In such an example, the pieces may be relatively large and degrade to relatively small pieces (e.g., which may pass through one or more openings, etc.).

As mentioned, equipment may include fracturing equipment where such equipment may be employed to generate one or more fractures in a geologic environment. As an example, a method to generate fractures can include a delivery block for delivering fluid to a subterranean environment, a monitor block for monitoring fluid pressure and a generation block for generating fractures via fluid pressure. As an example, the generation block may include activating one or more fractures. As an example, the generation block may include generating and activating fractures. As an example, activation may occur with respect to a pre-existing feature such as a fault or a fracture. As an example, a pre-existing fracture network may be at least in part activated via a method that includes applying fluid pressure in a subterranean environment. The foregoing method may be referred to as a treatment method or a “treatment”. Such a method may include pumping an engineered fluid (e.g., a treatment fluid) at high pressure and rate into a reservoir via one or more bores, for example, to one or more intervals to be treated, which may cause a fracture or fractures to open (e.g., new, pre-existing, etc.).

As an example, a fracture may be defined as including “wings” that extend outwardly from a bore. Such wings may extend away from a bore in opposing directions, for example, according in part to natural stresses within a formation. As an example, proppant may be mixed with a treatment fluid to keep a fracture (or fractures) open when a treatment is complete. Hydraulic fracturing may create high-conductivity communication with an area of a formation and, for example, may bypass damage that may exist in a near-wellbore area. As an example, stimulation treatment may occur in stages. For example, after completing a first stage, data may be acquired and analyzed for planning and/or performance of a subsequent stage.

Size and orientation of a fracture, and the magnitude of the pressure to create it, may be dictated at least in part by a formation's in situ stress field. As an example, a stress field may be defined by three principal compressive stresses, which are oriented perpendicular to each other. The magnitudes and orientations of these three principal stresses may be determined by the tectonic regime in the region and by depth, pore pressure and rock properties, which determine how stress is transmitted and distributed among formations.

Where fluid pressure is monitored, a sudden drop in pressure can indicate fracture initiation of a stimulation treatment, as fluid flows into the fractured formation. As an example, to break rock in a target interval, fracture initiation pressure exceeds a sum of the minimum principal stress plus the tensile strength of the rock. To determine fracture closure pressure, a process may allow pressure to subside until it indicates that a fracture has closed. A fracture reopening pressure may be determined by pressurizing a zone until a leveling of pressure indicates the fracture has reopened. The closure and reopening pressures tend to be controlled by the minimum principal compressive stress (e.g., where induced downhole pressures exceed minimum principal stress to extend fracture length).

After performing fracture initiation, a zone may be pressurized for furthering stimulation treatment. As an example, a zone may be pressurized to a fracture propagation pressure, which is greater than a fracture closure pressure. The difference may be referred to as the net pressure, which represents a sum of frictional pressure drop and fracture-tip resistance to propagation (e.g., further propagation).

As an example, a method may include seismic monitoring during a treatment operation (e.g., to monitor fracture initiation, growth, etc.). For example, as fracturing fluid forces rock to crack and fractures to grow, small fragments of rock break, causing tiny seismic emissions, called microseisms. Equipment may be positioned in a field, in a bore, etc. to sense such emissions and to process acquired data, for example, to locate microseisms in the subsurface (e.g., to locate hypocenters). Information as to direction of fracture growth may allow for actions that can “steer” a fracture into a desired zone(s) or, for example, to halt a treatment before a fracture grows out of an intended zone. Seismic information (e.g., information associated with microseisms) may be used to plan one or more stages of fracturing operations (e.g., location, pressure, etc.).

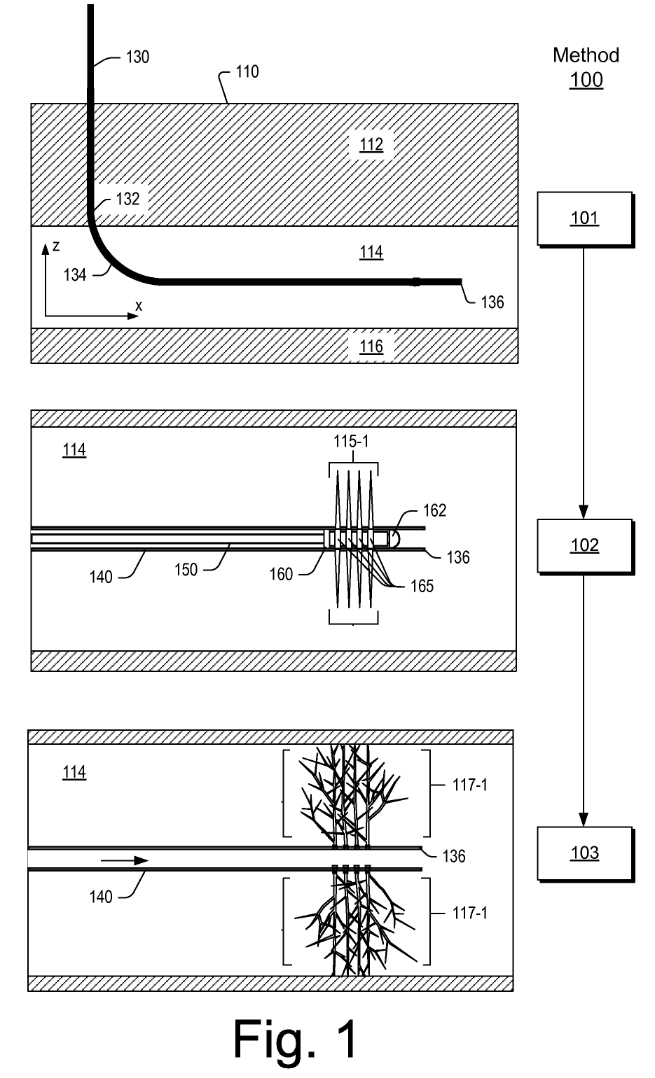

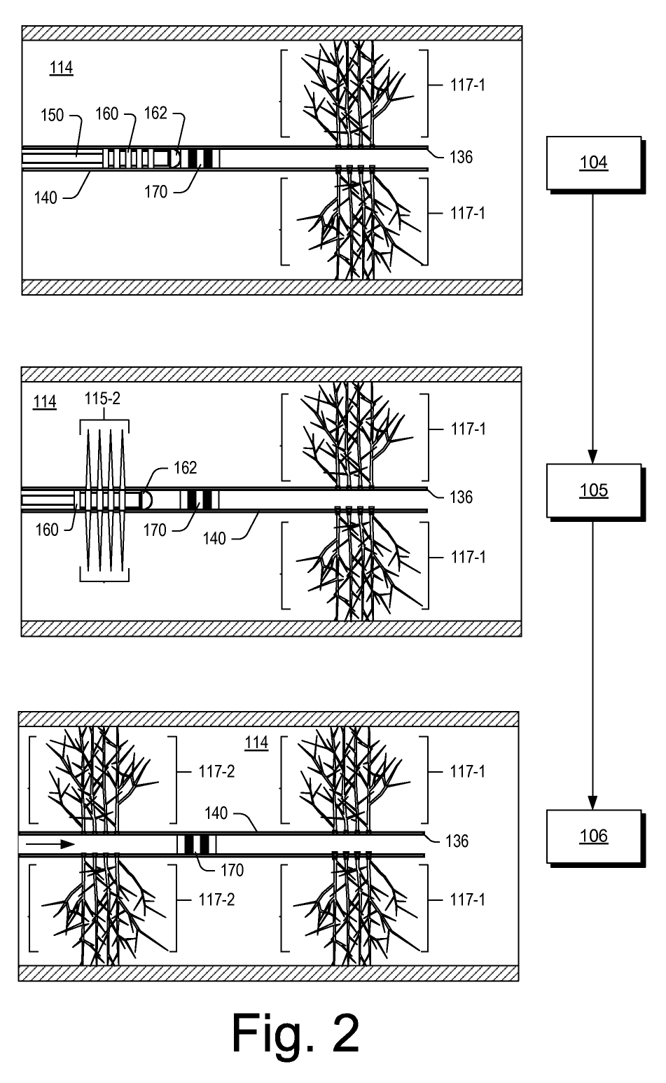

FIGS. 1 and 2 show an example of a method 100 that includes generating fractures. As shown, the method 100 can include various operational blocks such as one or more of the blocks 101, 102, 103, 104, 105 and 106. The block 101 may be a drilling block that includes drilling into a formation 110 that includes layers 112, 114 and 116 to form a bore 130 with a kickoff 132 to a portion defined by a heel 134 and a toe 136, for example, within the layer 114.

As illustrated with respect to the block 102, the bore 130 may be at least partially cased with casing 140 into which a string or line 150 may be introduced that carries a perforator 160. As shown, the perforator 160 can include a distal end 162 and charge positions 165 associated with activatable charges that can perforate the casing 140 and form channels 115-1 in the layer 114. Next, per the block 103, fluid may be introduced into the bore 130 between the heel 134 and the toe 136 where the fluid passes through the perforations in the casing 140 and into the channels 115-1. Where such fluid is under pressure, the pressure may be sufficient to fracture the layer 114, for example, to form fractures 117-1. In the block 103, the fractures 117-1 may be first stage fractures, for example, of a multistage fracturing operation.

Per the block 104, additional operations are performed for further fracturing of the layer 114. For example, a plug 170 may be introduced into the bore 130 between the heel 134 and the toe 136 and positioned, for example, in a region between first stage perforations of the casing 140 and the heel 134. Per the block 105, the perforator 160 may be activated to form additional perforations in the casing 140 (e.g., second stage perforations) as well as channels 115-2 in the layer 114 (e.g., second stage channels). Per the block 106, fluid may be introduced while the plug 170 is disposed in the bore 130, for example, to isolate a portion of the bore 130 such that fluid pressure may build to a level sufficient to form fractures 117-2 in the layer 114 (e.g., second stage fractures).

In a method such as the method 100 of FIGS. 1 and 2, it may be desirable that a plug (e.g., the plug 170) includes properties suited to one or more operations. Properties of a plug may include mechanical properties (e.g., sufficient strength to withstand pressure associated with fracture generation, etc.) and may include one or more other types of properties (e.g., chemical, electrical, etc.). As an example, it may be desirable that a plug degrades, that a plug seat degrades, that at least a portion of a borehole tool degrades, etc. For example, a plug may be manufactured with properties such that the plug withstands, for a period of time, conditions associated with an operation and then degrades (e.g., when exposed to one or more conditions). In such an example, where the plug acts to block a passage for an operation, upon degradation, the passage may become unblocked, which may allow for one or more subsequent operations.

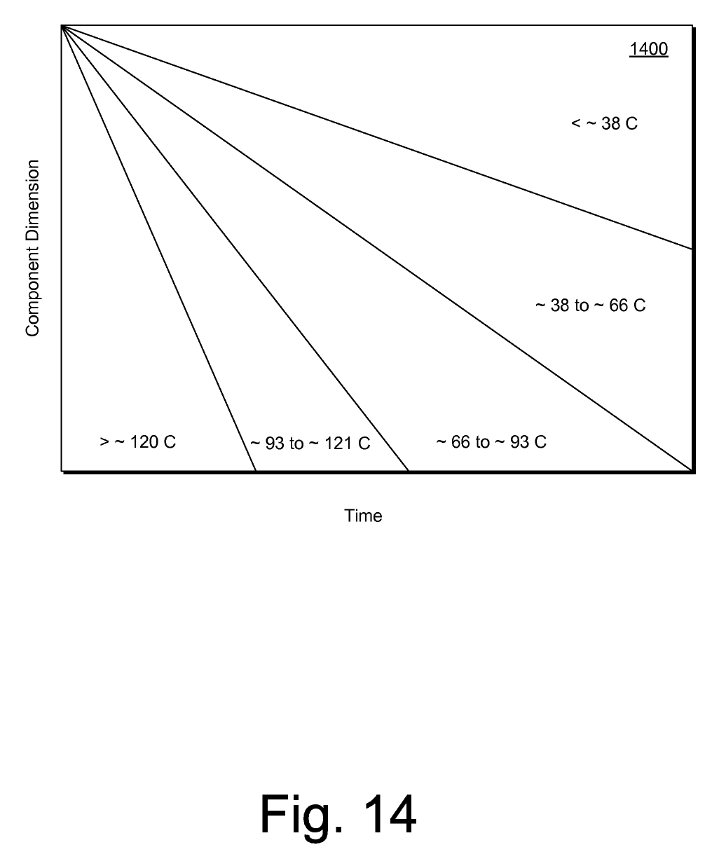

As an example, a component may be degradable upon contact with a fluid such as an aqueous ionic fluid (e.g., saline fluid, etc.). As an example, a component may be degradable upon contact with well fluid that includes water (e.g., consider well fluid that includes oil and water, etc.). As an example, a component may be degradable upon contact with a fracturing fluid (e.g., a hydraulic fracturing fluid). FIG. 14 shows an example plot 1400 of degradation time versus a component dimension for various temperatures where the component is in contact with a fluid that is at least in part aqueous (e.g., include water as a medium, a solvent, a phase, etc.).

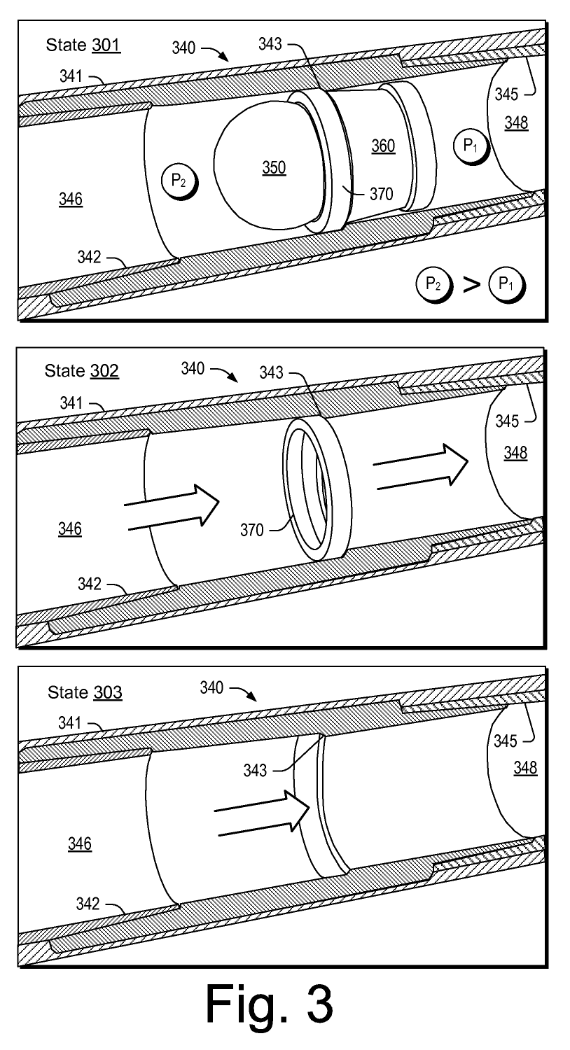

FIG. 3 shows an example of equipment in various states 301, 302 and 303. As shown, the equipment can include a casing 340 that include various components 341, 342, 343 and 345. For example, the component 342 may define a bore 346 and the component 345 may define a bore 348 where the component 343 includes features (e.g., reduced diameter, conical shape, receptacle, etc.) that can catch a ring component 370 that is operatively coupled to a plug component 360 where the ring component 370 and the plug component 360 may position and seat a plug 350 in the casing 340. As an example, a seal may be formed by the plug 350 with respect to the plug component 360 and/or the ring component 370 and, for example, a seal may be formed by the ring component 370 with respect to the component 343. In such an approach, the seals may be formed in part via fluid pressure in a manner where increased pressure acts to increase seal integrity (e.g., reduce clearances that may be subject to leakage). As an example, the ring component 370 may be an upper component (e.g., a proximal component) of a plug seat and the plug component 360 may be a lower component (e.g., a distal component) of the plug seat.

As shown in the state 301, the plug 350 may be seated such that the bore 346 (e.g., of a first zone) is separated (e.g., isolated) from the bore 348 (e.g., of a second zone) such that fluid pressure in the bore 346 (see, e.g., P₂) may be increased to a level beyond fluid pressure in the bore 348 (see, e.g., P₁). Where the plug 350 and the plug component 360 are degradable, for example, upon contact with fluid that may pressurize the bore 348, degradation of the plug 350 and the plug component 360 may transition the equipment from the state 301 to the state 302. As shown in the state 302, fluid may pass from the bore 346 to the bore 348, for example, via an opening of the ring component 370. Where the ring component 370 is degradable, for example, upon contact with fluid in the bore 346, degradation of the ring component 370 may transition the equipment from the state 302 to the state 303. In the state 303, the casing 340 may be the remaining equipment of the state 301 (e.g., the plug 350, the plug component 360 and the ring component 370 are at least in part degraded).

As an example, the plug 350, the plug component 360 and the ring component 370 may be components of a dissolvable plug and perforation system that may be used to isolate zones during stimulation (see, e.g., the method 100 of FIGS. 1 and 2). Such equipment may be implemented in, for example, cemented, uncemented, vertical, deviated, or horizontal bores (e.g., in shale, sandstone, dolomite, etc.).

As an example, the plug component 360 and the ring component 370 may be conveyed in a bore via a pump down operation (e.g., which may move the components 360 and 370 along a bore axis direction). As an example, a component or components may include adjustable features, for example, that allow a change in diameter to facilitate seating in a receptacle disposed in a bore. For example, a tool may interact with a component or components to cause a change in diameter or diameters (e.g., a change in form of one or more components). In the changed state, the component or components may catch and seat in a receptacle disposed in a bore (e.g., seat in a shoulder of a receptacle component).

As an example, the plug component 360 and the ring component 370 may be seated in a receptacle by a tool that may include one or more perforators. Once seated, the tool may be repositioned to perforate casing and form channels (e.g., in a layer or layers of rock). As an example, repositioning may occur multiple times, for example, to form multiple sets of perforations and multiple sets of channels. As an example, after perforating and channel formation, the plug 350 may be pumped down to contact the plug component 360 and/or the ring component 370, for example, to form a seal that can isolate one zone from another zone (e.g., one interval from another interval). Fluid pressure may be increased in an isolated zone as defined by the plug 350, the plug component 360 and the ring component 370 as positioned in a receptacle disposed in a bore such that the fluid enters channels via perforations of the isolated zone and generates fractures (e.g., new fractures, reactivated fractures, etc.).

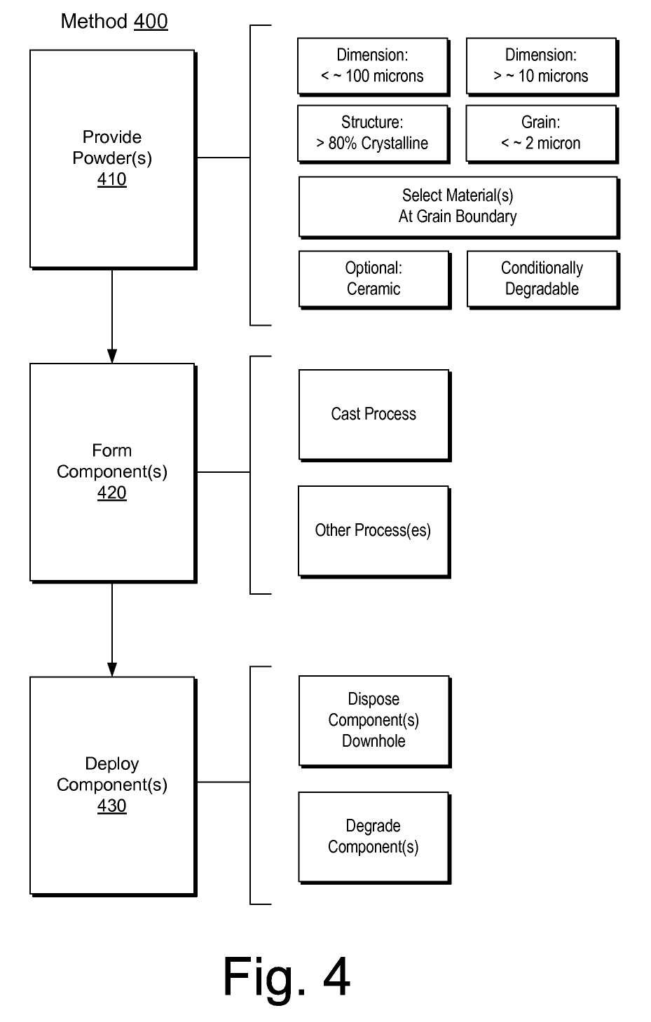

FIG. 4 shows an example of a method 400 that includes a provision block 410 for providing one or more powders, a formation block 420 for forming one or more components and a deployment block 430 for deploying one or more components, for example, as formed per the formation block 420 and optionally one or more additional components.

As an example, a powder may be defined as a dry, bulk solid composed of a number of particles that may, for example, flow relatively freely when shaken, tilted, etc. As an example, a powder may be a sub-class of a granular material.

As an example, a powder may be characterized by one or more properties, parameters, dimensions, etc. As an example, a powder may be characterized by one or more particle sizes (e.g., as to particles of the powder). Where a particle is spherical, the particle may be quantitatively defined by its diameter (e.g., or radius). Where a particle has an irregular shape that is not-spherical, a dimension may be defined by a diameter corresponding to the volume of the particle as equated to the volume of a sphere. As an example, a particle may be ellipsoidal and, for example, defined by a major axis length and/or a minor axis length.

As an example, a powder may include particles that are substantially spherical in shape (e.g., optionally characterized by sphericity). In such an example, a particle may be characterized by a particle size that corresponds to a diameter (e.g., assuming spherical shape). As an example, a powder may include particles with corresponding particle sizes that are within a range of less than about 100 microns and greater than about 10 microns.

As an example, particles may include crystalline structures, for example, a particle may be greater than 80 weight percent crystalline. In such an example, a particle may include an amorphous structure, for example, a particle may be less than about 20 weight percent amorphous and greater than about 80 weight percent crystalline.

Crystals tend to have relatively sharp, melting points as component atoms, molecules, or ions tend to be ordered with regularity (e.g., with respect to neighbors). An amorphous solid can exhibit particular characteristics, for example, upon cleaving or breaking, an amorphous solid tends to produce fragments with irregular surfaces and an amorphous solid tends to exhibit poorly defined patterns in X-ray imaging. An amorphous, translucent solid may be referred to as a glass.

Various types of materials may solidify into an amorphous form where, for example, a liquid phase is cooled with sufficient rapidity. Various solids may be intrinsically amorphous, for example, because atoms do not fit together with sufficient regularity to form a crystalline lattice or because impurities disrupt formation of a crystalline lattice. For example, although the chemical composition and the basic structural units of a quartz crystal and quartz glass are the same (e.g., SiO₂ and linked SiO₄ tetrahedra), arrangements of atoms in space are not. Crystalline quartz includes an ordered arrangement of silicon and oxygen atoms; whereas, in quartz glass, atoms are arranged relatively randomly. As an example, when molten SiO₂ is cooled rapidly (e.g., at a rate of about 4 K/min), it can form quartz glass; whereas, large quartz crystals (e.g., of the order of a centimeter or more) may have had cooling times of the order of years (e.g., thousands of years).

Aluminum crystallizes relatively rapidly; whereas, amorphous aluminum may form when liquid aluminum is cooled at a rate of, for example, about 4×10¹³ K/s. Thus, cooling rate of aluminum can determine how atoms arrange themselves (e.g., regularly or irregularly).

As an example, a particle may be polycrystalline, for example, composed of crystallites (e.g., grains) that can vary in size and orientation. As an example, grain size may be determined using a technique such as X-ray diffraction, transmission electron microscopy, etc.

A grain boundary may be defined as the interface between two grains in a polycrystalline material. Grain boundaries, defects in crystal structure, tend to decrease electrical and thermal conductivity of material. Grain boundaries may be sites for precipitation of one or more phases, which may be referred to as grain boundary material. Grain boundaries may disrupt motion of dislocations through a material. As an example, reduction of grain size may improve strength, for example, as described by the Hall-Petch relationship.

As an example, grain boundaries may meet at a so-called grain boundary triple point (GBTP). At a GBTP (e.g., a volumetric space), a phase or phases (e.g., of grain boundary material) may exist that differ from that of crystalline material in a grain (e.g., a crystallite).

As an example, a powder may include particles that include grain sizes of less than about 2 microns. As an example, grain sizes may be less than about 1 micron. As an example, average grain sizes may be less than about 0.5 microns (e.g., less than about 500 nm). As an example, average grain sizes may be less than about 200 nm. As an example, material that exists between grains may be of a dimension of an order of tens of nanometers to an order of hundreds of nanometers. As an example, material that exists between grains may be of a dimension that is less than an average grain size. For example, consider grains with an average grain size of the order of hundreds of nanometers and grain boundary material with an inter-grain spacing dimension of the order of tens of nanometers.

As an example, a powder particle may include grains that include one or more materials at their boundaries. For example, a grain may be bound by a select material at its boundaries. As an example, a grain boundary material may coat a grain such that the grain is substantially encapsulated by the grain boundary material. As an example, a grain boundary material may be described as “wetting” a grain, for example, a grain boundary material may be continuous and wet an entire surface (e.g., boundary) of a grain. As an example, a particle can include grains that are in a continuum of a grain boundary material. In such an example, the grains may be spaced from each other by the grain boundary material. As an example, a size of the boundary (or the spacing between grains) may be of the order of tens of nanometers to hundreds of nanometers. The spacing between grains (e.g., the size of the grain boundary) may be determined at least in part based on the surface tension of the grain boundary material and the grain. Thus, for example, spacing may vary depending on the material in the grain boundary and the material of the grain. As an example, strength of a powder particle may be approximated at least in part by a relationship such as, for example: σ∝1/√d̅, where d̅ is the average grain size and σ is the energy of the grain boundary.

As an example, to form a continuous grain boundary, a boundary forming component of a melt may be greater than about two percent by weight. For example, consider a melt of an aluminum alloy and gallium where the gallium is present at a weight percent greater than about two percent and less than about 20 percent (e.g., optionally less than about 10 percent, and in some examples less than about five percent). In such an example, atomization of the melt can form particles with grains that reside in a continuum of grain boundary material that includes gallium. In such an example, more than about 90 percent of the gallium can be preferentially segregated to the grain boundary (e.g., located within the grain boundary material). While higher percentages of gallium may optionally be included in a melt, in general, a higher the percentage of gallium can result in formation of globular nodules within a particle. Such globular nodules can result in a reduction of mechanical strength of a particle. Where a powder is to be used to form a part or a tool (e.g., a downhole tool) that is to withstand certain mechanical force(s), yet be degradable, the powder may be formed of a melt that is tailored to meet mechanical force and degradability criteria. As an example, a degradability criterion may be met by including at least about two percent by weight of a select material (e.g., or materials) in a melt. In such an example, a powder formed by the melt can be at least about two percent by weight of the select material (e.g., considering material conservation). As an example, a powder may be of at least about two percent by weight of a select material (e.g., or select materials).

As an example, a melt may include greater than about 80 percent by weight of an aluminum alloy and greater than about two percent by weight of a select material or materials. In such an example, consider as the select material, or materials, one or more of gallium, indium, tin, bismuth, and lead. As an example, a select material or materials may include one or more basic metals where, for example, basic metals include gallium, indium, tin, thallium, lead and bismuth (e.g., basic metals of atomic number of 31 or greater). As an example, grain boundary material may include aluminum, which is a basic metal with an atomic number of 13, in addition to one or more other basic metals. As an example, a basic metal may be a post-transition metal (e.g., metallic elements in the periodic table located between the transition metals (to their left) and the metalloids (to their right) and including gallium, indium and thallium; tin and lead; and bismuth). As an example, a melt may optionally include mercury. As an example, a powder formed of such a melt can include mercury, which may be a boundary material that bounds grains of particles of the powder.

As an example, a melt and a powder formed from the melt can include one or more alkali metals. For example, consider one or more of lithium, sodium, and potassium. As an example, a melt and a powder formed from the melt can include one or more alkaline earth metals. For example, consider one or more of beryllium, magnesium, calcium, strontium and barium.

As an example, one or more of an alkali metal, an alkaline earth metal, or a basic metal may be used as the select material or materials for a melt. As an example, a melt may include gallium and indium. The gallium and indium may preferentially segregate to the grain boundary, for example, during a severe plastic deformation process, resulting in a desired powder particle. Materials of an aluminum alloy, such as, for example, aluminum, magnesium, silicon, copper, for example, may also appear in the grain boundary.

As an example, consider cooling a melt that includes aluminum, magnesium and gallium such that grains form with a first amount of gallium and such that at the boundaries of the grains material forms with a second amount of gallium that exceeds the first amount of gallium. In such an example, the material at the boundaries may be characterized as gallium enriched. In such an example, the amount of gallium in the grains may be negligible (e.g., grains may be formed of an aluminum alloy substantially devoid of gallium).

As an example, a material may include aluminum (e.g., melting point of about 1220 degrees F. or about 660 degrees C.), magnesium (e.g., melting point of about 1200 degrees F. or about 650 degrees C.) and gallium (e.g., melting point of about 86 degrees F. or about 30 degrees C.). Such a material may be provided in a molten state and cooled to form grains and boundaries where the boundaries are enriched in gallium (e.g., a low melting point material of the bulk material).

As an example, a material may include gallium, indium and tin. In such an example, gallium, indium (e.g., melting point of about 314 degrees F. or about 157 degrees C.) and tin (e.g., melting point of about 450 degrees F. or about 232 degrees C.) may alloy (e.g., forming a eutectic alloy with a melting point of about −19 degrees C. or about −2 degrees F.). Such a material may be provided in a molten state and cooled to form grains and boundaries where the boundaries are enriched in at least gallium (e.g., as an alloy of gallium, indium and tin as a low melting point material of the bulk material).

As an example, a material may include aluminum, magnesium and copper (e.g., melting point of about 1990 degrees F. or about 1090 degrees C.). In such an example, the material may experience an increase in strength when subjected to solution heat treatment and quenching. As an example, an aluminum, magnesium and copper alloy may increase in strength and exhibit considerable ductility upon aging at ambient temperature (e.g., about 25 degrees C.).

As an example, an alloy may be characterized by a series designation. For example, consider the following series that include aluminum: 1000 series alloys that include a minimum of 99 weight percent aluminum content by weight, 2000 series alloys that include copper, 3000 series alloys that include manganese, 4000 series alloys that include silicon, 5000 series alloys that include magnesium, 6000 series alloys that include magnesium and silicon, 7000 series alloys that include zinc, and 8000 series alloys that include one or more other elements not covered by other series (e.g., consider aluminum-lithium alloys).

As an example, alloys that include aluminum may be represented by designations such as: 1xx.x series that include a minimum of 99 percent aluminum, 2xx.x series that include copper, 3xx.x series that include silicon, copper and/or magnesium, 4xx.x series that include silicon, 5xx.x series that include magnesium, 7xx.x series that include zinc, 8xx.x series that include tin and 9xx.x that include other elements.

As an example, a material may be degradable and, for example, an alloy may be degradable (e.g., a degradable alloy). As an example, a material may degrade when subject to one or more conditions (e.g., over time). For example, consider one or more environmental conditions and/or “artificial” conditions that may be created via intervention, whether physical, chemical, electrical, etc. As an example, conditions can include temperature, pressures (e.g., including loads and forces), etc.

As an example, a degradable alloy may degrade at least in part due to presence of internal galvanic cells, for example, between structural heterogeneities (e.g. phases, internal defects, inclusions, etc.). As an example, a degradable material may resist passivation or, for example, formation of one or more stable protective layers.

As an example, a degradable alloy can include one or more alloying elements “trapped” in “solid solution”. As an example, a material may include a metal such as aluminum, which may be impeded from passivating or building a resilient protective layer (e.g., aluminum oxide such as Al₂O₃).

As an example, a material can include one or more ceramics. For example, a material can include an inorganic, nonmetallic solid that includes metal, nonmetal or metalloid atoms, at least in part held in ionic and covalent bonds. A ceramic may be regular and/or irregular in structure, for example, atoms may be regularly oriented and crystalline, semi-crystalline and/or amorphous (e.g., ceramic glass). As an example, a ceramic may be an oxide (e.g., alumina, beryllia, ceria, zirconia, etc.). As an example, a ceramic may be a nonoxide (e.g., carbide, boride, nitride, silicide, etc.). As an example, a ceramic may include an oxide and a nonoxide.

As an example, a material can include one or more oxides. As an example, during processing of an alloy in the presence of oxygen, one or more oxides may form. For example, consider an alloy that includes aluminum where alumina (e.g., an aluminum oxide, Al₂O₃) forms. As another example, consider an alloy that includes silicon where silica (e.g., a silicon oxide, SiO₂) forms. As an example, an oxide may be a dispersed material in a particle. As an example, an oxide may be of a size of about 10 nm or less and optionally about 5 nm or less.

As an example, a material can include concentrations of one or more solute elements, for example, trapped in interstitial and in substitutional solid solutions. As an example, concentrations, which may be spatially heterogeneous, of such one or more solute elements, may be controlled through chemical composition, processing, etc. As an example, consider rapid cooling where solubility is higher than at ambient temperature or temperature of use.

As an example, a material may include one or more elements or phases that liquate (e.g., melt, etc.) once elevated beyond a certain temperature, pressure, etc., which for alloys may be predictable from phase diagrams, from thermodynamic calculations (e.g., as in the CALPHAD method), etc.

As an example, a material may “intentionally” fail via liquid-metal embrittlement, for example, as in an alloy that includes gallium and/or indium. As an example, a degradable material may include an alloy or alloys and possess phases that may be susceptible to creep (e.g., superplastic) deformation (e.g., under intended force, etc.), possess phases that are brittle (e.g., which may rupture in response to impact, etc.).

As an example, a degradable material may include a calcium alloy such as, for example, calcium-lithium (Ca—Li), calcium-magnesium (Ca—Mg), calcium-aluminum (Ca—Al), calcium-zinc (Ca—Zn), calcium-lithium-zinc (Ca—Li—Zn), etc. As an example, in a calcium-based alloy, lithium may be included in concentrations, for example, between about 0 to about 10 weight percent (e.g., to enhance reactivity, etc.). As an example, concentrations ranging from about 0 to about 10 weight percent of one or more of aluminum, zinc, magnesium and silver may enhance mechanical strength.

As an example, a material may include one or more magnesium-lithium (Mg—Li) alloys, for example, enriched with tin, bismuth and/or one or more other low-solubility alloying elements.

As an example, a material can include one or more alloys of aluminum. As an example, a material may include one or more of an aluminum-gallium (Al—Ga) alloy and an aluminum-indium (Al—In) alloy. As an example, a material may include one or more of an aluminum-gallium-indium (Al—Ga—In) and an aluminum-gallium-bismuth-tin (Al—Ga—Bi—Sn) alloy.

As an example, a material can include aluminum, gallium and indium. For example, consider a material with an alloy of about 80 weight percent aluminum, about 10 weight percent gallium and about 10 weight percent indium. Such a material may include Vickers microhardness (500 g) of about 32 (#1), 34 (#2), 34 (#3), 30 (#4), 35 (#5), 36 (#6) and 33 (average) and estimated strength of about 100 (MPa), 15 (ksi) and 1.5 (normalized).

As an example, a component may be formed of material that provides a desired degradation rate and desired mechanical properties (e.g., strength, etc.). As an example, a degradation rate may depend upon one or more conditions (e.g., temperature, pressure, fluid environments), which may be exist in an environment and/or may be achieved in an environment (e.g., via one or more types of intervention). As an example, a material may be conditionally degradable (e.g., degradable upon exposure to one or more conditions).

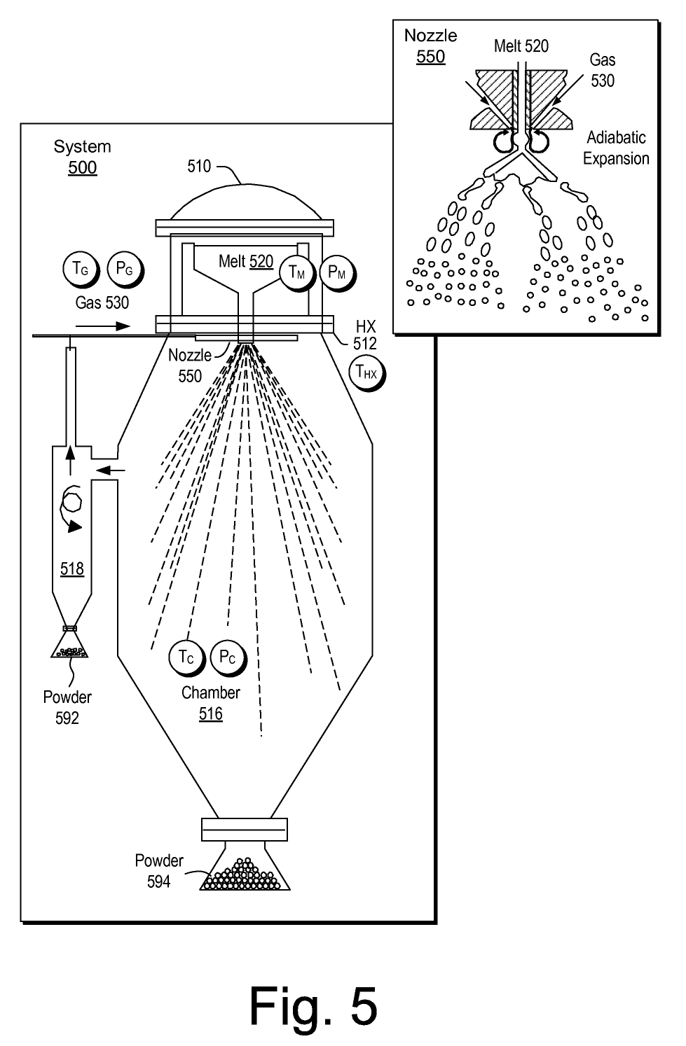

FIG. 5 shows an example of a system 500 that can process a melt 520 using gas 530 to form particles. In such an example, the particles may be composed of melt constituents and/or composed of melt constituents and optionally one or more gas constituents (e.g., consider oxygen in the gas 520 forming an oxide such as alumina upon exposure to aluminum in the melt 520). Particles formed via the system 500 may be powder particles. The system 500 may be considered to be a powder metallurgical system that can be implemented using powder metallurgy technology.

As shown in FIG. 5, the system 500 includes a vacuum induction furnace 510, an optional heat exchanger 512 (HX), a chamber 516, a cyclone chamber 518, and a nozzle 550. As illustrated, a rapid expansion of the gas 530 as provided to the nozzle 550 can break up the melt 520, which may form a thin sheet and subsequently ligaments, ellipsoids and/or spheres (e.g., particles). In an example of an inert gas atomization process, particles formed may be substantially spheroidal. As an example, an atomization process may be a gas atomization process (e.g., including inert and/or non-inert gas), a water atomization process, a mechanical pulverization process, etc.

Particles may be collected in the chamber 516 and in the cyclone chamber 518, which can allow gas to exit and optionally recycle (e.g., with make-up gas, etc. to maintain a gas composition where multiple gases may be used). In such an example, the cyclone chamber 518 may collect particles that are finer than the particles collected in the chamber 516. Particles of either or both chambers 516 and 518 may be combined, separated, etc.

As to operational parameters of an atomization process, consider, for example, alloy composition, melt feed rate, melt temperature, melt viscosity, heat exchanger temperature (e.g., heat transfer rate, etc.), gas pressure and temperature, type of gas, nozzle geometry, etc. Gas atomization may produce particles that are substantially spherical in their shapes and that include grains and grain boundaries. As an example, gas atomization may produce particles that include crystalline structure and/or amorphous structure.

As an example, a melt temperature (see, e.g., T_{M}) may be a superheated temperature. As an example, a melt temperature may be greater than about 650 degrees C. (e.g., greater than about 700 degree C. and optionally greater than about 800 degrees C.). As an example, a chamber such as the chamber 816 may be at a temperature of about 70 degrees C. (e.g., a temperature of the order of hundreds of degrees C. less than a melt temperature). As an example, gas may expand relatively adiabatically, which may facilitate cooling of melt and reducing thermal shock.

As an example, heat transfer may occur within a system such as the system 800 such that particles are crystalline, amorphous or crystalline and amorphous.

As an example, a method may include cooling melt at a rate that causes at least a portion of a particle formed from the melt to be amorphous. For example, a method may include cooling via a cryogenic cooled target (e.g., consider the heat exchanger 512 of the system 500). As an example, a cryogenic cooled target may be positioned in front of an atomizing nozzle, for example, to achieve a cooling rate (e.g., R_{C}) where vitrification occurs for atomized (melt) droplets (e.g., to be at least in part a metallic glass structure, which may be a bulk metallic glass structure). As an example, a material may be characterized at least in part by a glass transition temperature (T_{g}) where below that temperature an amorphous material may be glassy (e.g., whereas above T_{g} it may be molten).

As an example, a method may include introduction of a gas at a low temperature. For example, consider introduction of helium in an atomization stream (e.g., introduction of helium as a gas, in a gas provided to a nozzle or nozzles).

As an example, a method may include increasing the superheating temperature of a melt, which may increase a driving force (e.g., a temperature differential) as to heat transfer (e.g., cooling). As an example, a method may include forming particles of a particular size or smaller such that heat transfer may occur more rapidly for the particles. For example, consider selecting a nozzle dimension (e.g., diameter, slit width, etc.) to achieve a particular particle size. As an example, a method may include analyzing dendrite arm spacing during cooling and adjusting one or more parameters of a gas atomization process such that amorphous particles may be formed.

As an example, a melt may be analyzed as to one or more properties such as, for example, a glass-transition or vitrification temperature (e.g., T_{g}). As an example, a system may be operated such that transformation takes place at the glass-transition temperature, T_{g}, below an equilibrium temperature for the solidification (e.g., a liquidus temperature, T_{L}), which may act to “freeze” an atomized melt in a non-equilibrium state (e.g., at least in part as an amorphous material). As an example, a liquidus temperature may be the maximum temperature at which crystals can co-exist with a melt in thermodynamic equilibrium. As an example, a method may consider a solidus temperature (Ts) that quantifies a point at which a material crystallizes. As an example, for a material, a gap may exist between its liquidus and solidus temperatures such that material can include solid and liquid phases simultaneously (e.g., akin to a slurry).

As an example, a method may include cooling a melt to produce an amorphous melt-span ribbon. In such an example, the ribbon may be further processed, for example, by mechanical crushing of the ribbon to form a powder.

As an example, a water reactive powder (e.g., a degradable powder) may be processed via Equal Channel Angular Pressing (ECAP). In such an example, the powder may be produced by gas atomization (e.g., using one or more gases, optionally one or more inert gases), by ball milling, by crushing or other mechanical means, by sol-gel, etc.

As an example, a powder may include particles of one or more particle size distributions. For example, consider D90 less than about 44 microns (e.g., a mesh size of about 325), D90 less than about 60 microns, D90 less than about 90 microns, etc.

As an example, where a method includes processing via ECAP, the method can include shearing of grains in consolidated or unconsolidated powder through a channeled die at low to high angles. As an example, ECAP can include passing material through a die (e.g., or dies) at various angles, which may abet refining of grains (e.g., of a water reactive powder), for example, to achieve a desired minimum grain size (e.g., after a certain number of ECAP passes). As an example, a method can include ECA pressing, for example, at one or more temperatures. In such an example, the pressing may cause in situ consolidation of powder into a solid. Such a solid may be further consolidated into an approximately 100 percent dense billet (e.g., via forging, extrusion, etc.).

As an example, a method can include performing ECAP to abet refining of grains in an SPD powder, for example, to achieve a minimum grain size (e.g., after a certain number of ECAP passes).

As an example, a powder or a blend of powders may be processed to achieve one or more desired properties such as, for example, one or more desired properties of strength, ductility, fracture toughness, thermal stability, microstructure, etc.

As an example, a desired strength may be achieved at least in part via control of grain size. As an example, a desired ductility may be achieved at least in part via control of grain size. As an example, a desired fracture toughness may be achieved at least in part via control of grain size. As an example, a desired thermal stability may be achieved at least in part via control of grain size. As an example, a desired microstructure may be achieved at least in part via control of grain size.

As an example, a method may include controlling grain size. For example, consider alternating grain size from the point of inflection of an inverse Hall-Petch trend (e.g., varying for different alloys, consider about 50 nm) to an upper limit of ultrafine grains (e.g., about 1000 nm or 1 micron). As an example, a method can include controlling grain size by controlling a number of ECAP passes.

As an example, a method can include processing water reactive powder via ECAP, for example, to tailor dissolution rate in a fluid, to tailor dissolution rates in various fluids, etc. As an example, a fluid may be a hydraulic fracturing fluid. As an example, a fluid may include a salt concentration or concentrations of salts. For example, consider a fluid that includes one or more of NaCl, KCl and MgCl₂. As an example, a fluid may be an aqueous fluid. Such an aqueous fluid may include one or more salts. As an example, a method may include varying percentages of one or more inhibited acid that may be used in one or more spearheading operations during hydraulic fracturing. As an example, a method can include tailoring dissolution rate (e.g., degradation rate) by controlling grain size. As an example, ECAP may be used for refining grains of an SPD powder, for example, to achieve a minimum grain size after certain number of ECAP passes (e.g., optionally alternating grain size from the point of inflection of an inverse Hall-Petch trend.

As an example, dissolution rate (e.g., degradation rate) may be influenced by disruption of a continuous grain boundary network. One or more characteristics of such a network may be influenced by number of ECAP passes. As an example, dissolution rate (e.g., degradation rate) may be influenced by precipitation of an additional phase of dispersoids, for example, as may be processed during high temperature ECA pressing.

As an example, a method can include making a high strength degradable alloy with ductility from a brittle cast equivalent for load bearing applications via powder metallurgy (PM) technology. In such an example, the high strength degradable alloy may be utilized in a variety of contexts including, for example, downhole contexts (see, e.g., various components of FIGS. 1, 2 and 3).

As an example, a degradable alloy may be designed to dissolve upon exposure to one or more downhole conditions. As an example, a degradable alloy may be used to make at least a portion of one or more downhole tools or apparatuses that can withstand pressures, such as those used in a fracturing operation (see, e.g., FIGS. 1, 2 and 3). For example, a degradable alloy may be used to create one or more components used in a fracturing operation. For example, a degradable alloy may be used in some embodiments as an obstruction member (e.g., a dart, a ball, etc.) and/or one or more parts of a seat configured to catch the obstruction member. As a material may be designed to dissolve under downhole conditions (e.g., after completion of at least a portion of a fracturing operation), one or more components made of the degradable alloy can disappear (e.g., optionally without further intervention).

As an example, fine-grained (FG) materials may be defined as materials having grain sizes whose linear dimensions are of the order of about 10⁻⁶ meters or a micrometer (e.g., μm, or micron, μ). In some embodiments, one or more physical properties of such FG materials may result in enhanced strength when compared to a coarse-grained counterpart, for example, due to Hall-Petch strengthening of a FG material. As an example, a FG material may exhibit fair elongation to failure when compared to a coarse-grained counterpart.

As an example, a FG material may exhibit characteristics associated with reduced size or dimensionality of fine crystallites as well as from numerous interfaces between adjacent crystallites. As an example, a FG material may be formed where material of crystallites (e.g., grains) have a first composition and where material between crystallites (e.g., at grain boundaries) have a second composition that differs from the first composition. For example, where a bulk FG material includes aluminum and gallium, a second composition (e.g., of material between grains) may be gallium enriched when compared to a first composition (e.g., of material forming grains).

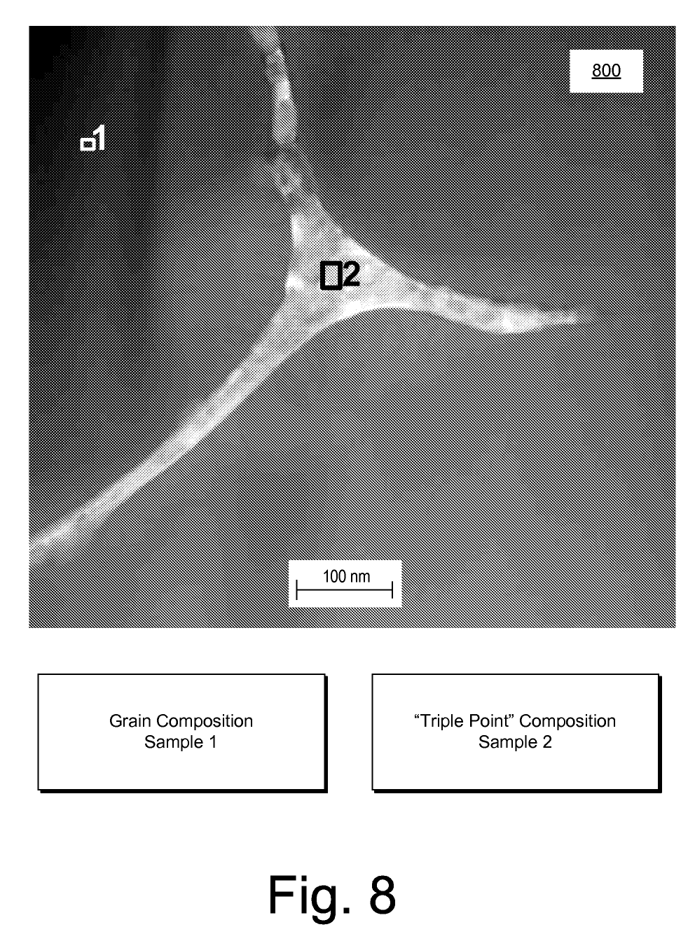

Various routes exist for engineering alloys with fine grains. For example, severe plastic deformation may result in formation of an ultra-fine or a nanostructure in a bulk material. As another example, consider the system 800 of FIG. 8 where gas atomization (e.g., using inert and/or other gas or gasses) may result in production of controlled fines. For example, consider a gas atomization process that can generate particles that may be characterized at least in part by size (e.g., consider a size distribution of about 10 microns to about 20 microns). In such an example, grains in particles may be of the order of about a micron. As an example, particles may be formed via gas atomization that include grains of the order of less than about one micron (e.g., optionally less than about half a micron).

Consolidation of a powder to form a solid may be accomplished, for example, using Hot Isostatic Pressing (HIPing), Vacuum Hot Pressing (VHP) followed by back extrusion, or a warm working method. In such examples, a product may be a component, which may be, for example, a homogeneous engineering solid with desired mechanical properties and fracture toughness.

As an example, a consolidated solid (e.g., as produced at least in part from a powder) may include thermally stable fine grains that resist grain growth due to thermal activation, which may oppose degradation in their mechanical properties at elevated temperatures. As an example, combinations of high strength, enhanced ductility and/or high strain rate superplasticity may manifest in an alloy due to various competing mechanisms, for example, grain boundary sliding, etc. Further, cold work/processing, for example, forging, etc., may be applied to one or more consolidated solids to augment mechanical properties (e.g., to achieve one or more target criteria).

As an example, a degradable alloy (e.g., water reactive, etc.) may be processed to from a segregated brittle cast solid, a high strength engineering alloy, etc. As an example, a degradable alloy may be prepared via inert gas atomization (IGA) followed by consolidation via HIPing and/or Vacuum Hot Pressing and extrusion. In such an example, a resulting bulk alloy may include one or more sub-structural features. For example, consider a resulting bulk alloy that includes oxide particles resulting from breakup of oxide layers that are formed around metal particles during gas atomization to provide enhanced thermal stability and strength by mitigating dislocation motion.

As an example, a process may include one or more of the following: refining grains to develop a nano to ultrafine grained microstructure; Hall-Petch strengthening to increase strength; forming desirable grain boundaries to increase ductility (e.g., abetting grain boundary sliding to make a treated alloy high strain rate superplastic to enhance formability and working); dispersion strengthening (e.g., via introduction of one or more additional phase particles/oxides, which may result from the breakup of oxide layers that are formed around metal particles during gas atomization); and increasing thermal stability of a bulk alloy (e.g., synthesized through powder metallurgy technology via introduction of particles of an additional phase, which may impact drag).

As an example, a processed material (e.g., a resulting alloy, etc.) may exhibit one or more of the following: increased strength and ductility, relatively uniform properties (e.g., bulk homogeneity in comparison to a brittle, precipitate hardened cast counterpart material), increased thermal stability, and an ability to abet strain hardening through dislocation strengthening.

As an example, a method may include one or more of the following processes and/or produce a material that includes one or more properties listed below (e.g., of a desired high strength degradable alloy): inert gas atomization (IGA) of a brittle cast melt with controlled flow through one or more nozzles (e.g., optionally of varying sizes) to yield powder particles of varying mesh size; particulate (approximately 80 percent to approximately 100 percent (e.g., approximately 90 percent) screened distribution) with sizes varying between about 10 microns and about 70 microns (e.g., between about 20 microns and about 60 microns).

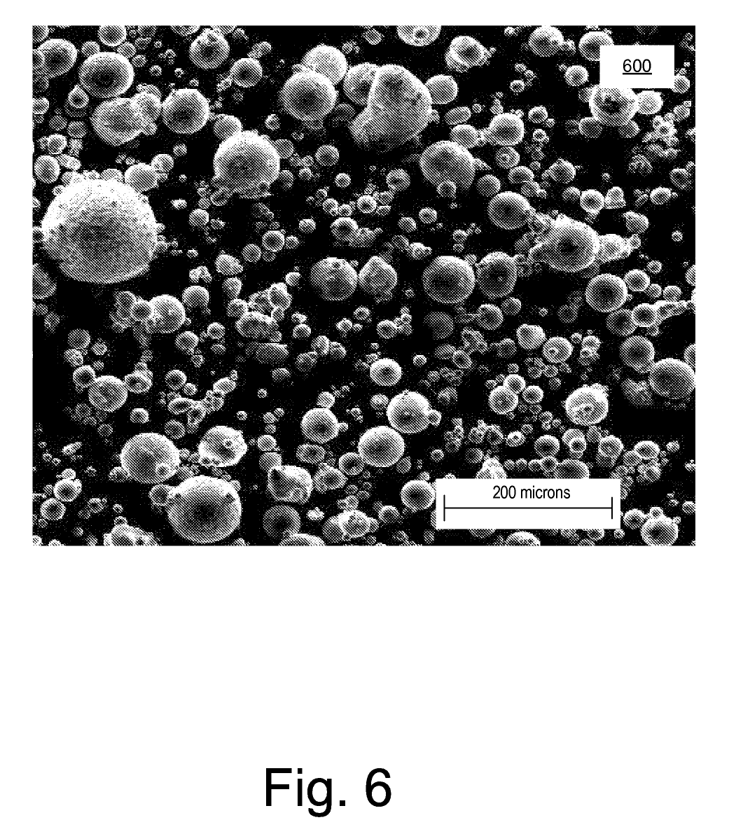

FIG. 6 shows a scanning electron micrograph 600 of particles produced via gas atomization of a brittle cast melt. Such particles may be formed by cooling the melt as it exits a nozzle (see, e.g., the nozzle 550 of the system 500 of FIG. 5). Such cooling may be adiabatic cooling. For example, adiabatic cooling can occur when pressure on an adiabatically isolated system is decreased, allowing it to expand, thus causing it to do work on its surroundings. When the pressure applied on a parcel of gas is reduced, the gas in the parcel is allowed to expand; as the volume increases, the temperature falls as internal energy decreases.

As an example, a gas atomization process may “capture” melt in a particle as a supersaturated solid solution. As an example, a particle may include properties that can reduce segregation of alloying constituents in solid solution. As an example, a gas atomization process may yield fine to ultrafine grain microstructure in particles that form a powder.

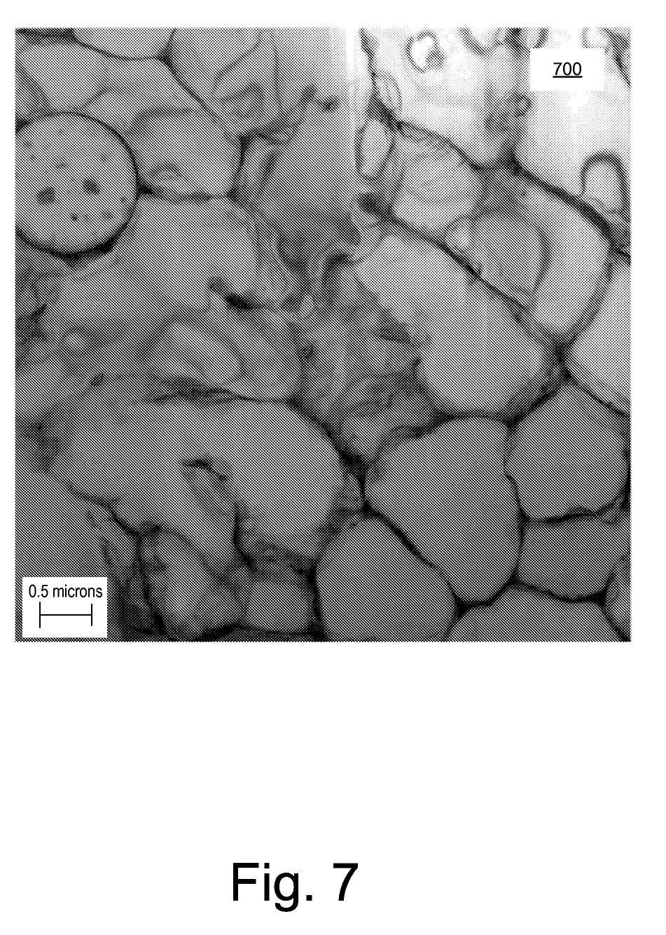

FIG. 7 shows an example of a transmission electron micrograph (TEM) 700 of a particle of a powder. The TEM 700 shows ultrafine grains with darker grain boundaries; noting Focus Ion Beam (FIB) sample preparation. Specifically, the TEM 700 shows that the particle includes grains with dimensions of the order of about one micron or less. The TEM 700 shows various grains that include dimensions of about 0.5 microns.

As an example, a process can generate particles with grains where, for example, the processing provides for segregation of one or more low melting point constituents at grain boundaries. In such an example, the one or more low melting point constituents can coat grains and through such coating form a galvanic couple.

As an example, particles of a powder may include grain boundary interfaces where intermetallic precipitates can form during one or more ageing process, which may, for example, result in additional strengthening of the material (e.g., alloy, alloy and ceramic, etc.).

As an example, a process may provide for weakening of grain boundary interfaces in a component formed of a powder produced via gas atomization, which may help to promote embrittlement of the boundaries and further enhance a degradation mechanism (e.g., or degradation mechanisms). For example, consider a particle of a material that includes aluminum and gallium where gallium enrichment at grain boundary interfaces may promote embrittlement of the boundaries and where at least gallium interacts with fluid in a manner that causes degradation of the particle. As an example, a component formed of such particles (e.g., via processing of such particles) may degrade upon exposure to fluid and via embrittlement.

As an example, a material may include one or more oxide dispersoids, which may provide enhanced thermal stability and strengthening, for example, due to pinning of grain boundaries and dislocations.

As an example, differential cooling of a warm powder may abet diffusion of one or more low melting point constituents from a trapped supersaturated solid solution to a grain interior along a grain boundary, for example, causing liquid-metal embrittlement, which may enhance a degradation mechanism (e.g., consider a mechanism where gallium interacts with fluid in a manner that causes degradation).

FIG. 8 shows an example of a TEM 800 that includes a triple junction between three grains (e.g., a GBTP) in a particle of a powder. The TEM 800 shows contrast and compositional differences between the grain boundary and the grain; noting Focus Ion Beam (FIB) sample preparation. The TEM 800 includes two windows that correspond to samples: Sample 1 for grain material composition and Sample 2 for grain boundary material composition.

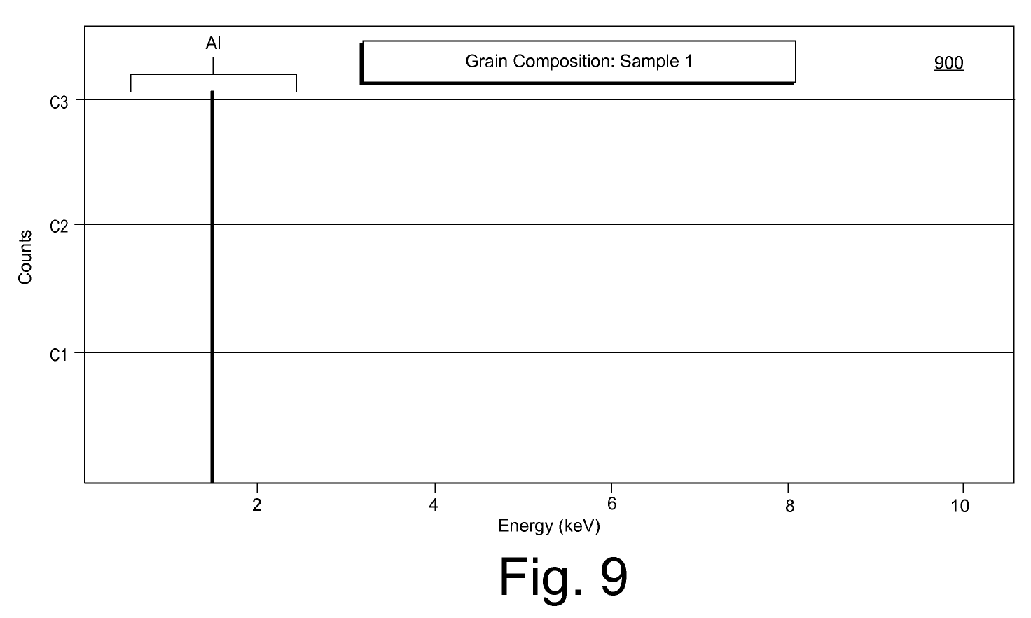

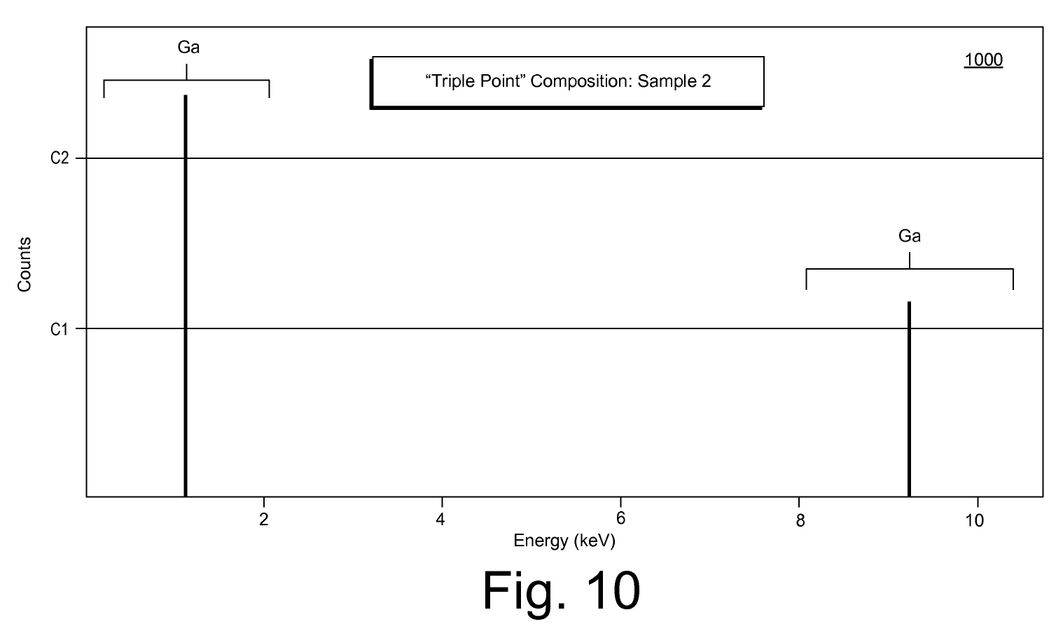

FIG. 9 shows a plot 900 of an energy-dispersive X-ray (EDX) analysis of composition of Sample 1 of the TEM 800 and FIG. 10 shows a plot 1000 of an EDX analysis of composition of Sample 2 of the TEM 800. EDX is an analytical technique that can be applied for elemental analysis or chemical characterization of a sample. EDX involves interaction of a source of X-ray excitation (e.g., electrons) and a sample where, for example, a number and energy of X-rays emitted from the sample can be measured by an energy-dispersive spectrometer (e.g., EDS). As energy of X-rays can be characteristic of the difference in energy between two shells, and of the atomic structure of an element from which they were emitted, this allows the elemental composition of the sample to be measured.

In EDX, X-rays may be characteristic X-rays that result when beam electrons eject inner shell electrons of the sample atoms or continuum (Bremsstrahlung) X-rays that result when the beam electrons interact with the nucleus of the sample atoms; noting that characteristic X-rays reveal themselves as peaks imposed upon a background of continuum X-rays. An EDX analysis may involve Auger spectroscopy, for example, where the energy of an Auger electron, like an X-ray, is characteristic of a sample atomic number from which it was derived. Auger electron production is favored for low atomic number elements; characteristic X-ray production dominates for high atomic number elements.

In EDX, characteristic X-ray lines may be designated according to the shell in which the initial vacancy occurs and the shell from which an electron drops to fill that vacancy. For example, if the initial vacancy occurs in the K shell and the vacancy filling electron drops from the adjacent (L) shell, a Kα X-ray is emitted. If the electron drops from the M shell (two shells away), the emitted x-ray is a Kβ X-ray. And, if an L-shell electron is ejected and an electron from the M-shell fills the vacancy, La radiation will be emitted. In EDX light elements can emit X-rays of the K series, intermediate elements can emit X-rays of the L series or K and L series; and heavy elements can emit X-rays of the M series or L and M series. K, L and M series X-rays can increase in energy with increasing atomic number.

The plots 900 and 1000 include data that demonstrate compositional differences between material of a grain and material at a grain boundary (e.g., material bounding one or more grains). In particular, these data indicate that one or more components of a melt segregate to grain boundaries during gas atomization such that grain material may have a characteristic composition and grain boundary material may have a different characteristic composition. In such an example, the gas may be considered to be inert gas in that the presence of a gas such as oxygen may be relatively low, for example, less than about 1000 ppm. As mentioned, oxygen, where present, may cause formation of one or more oxides (e.g., alumina, etc.).

In the plot 900 of FIG. 9, the count scale ranges from about 0 to C1, C2 and to greater than C3 and in the plot 1000 of FIG. 10, the count scale ranges from about 0 to C1 and to greater than C2. In the plot 900 of FIG. 9, an aluminum peak exceeding a count of C3 exists between about 1 and about 2 keV. In such an example, higher energies peaks may not exceed a count of C1. In the plot 1000 of FIG. 10, a gallium peak exceeding a count of C2 exists between about 1 and about 2 keV and at a higher energy of about 9 keV another gallium peak exists that exceeds a count of about C1. In an EDX analysis, depending on material in a melt, additional peaks may be recorded. For example, consider one or more peaks that may correspond to copper, carbon, oxygen, silicon, magnesium, indium, etc.

As an example, in a particle, material at a grain boundary may be enriched in gallium when compared to material in a grain. As an example, in a particle, material at a grain boundary may be enriched in indium when compared to material in a grain. As an example, in a particle, material at a grain boundary may be enriched in gallium and indium when compared to material in a grain.

As an example, a particle may include material at a grain boundary that, upon analysis, generates gallium counts at one or more energies of less than about 2 keV and generates counts gallium counts at one or more energies greater than about 8 keV. In such an example, a ratio of counts may be about two to one. As an example, such a particle may include material at a grain boundary that, upon analysis, generates indium counts at energies from about 2 keV to about 5 keV. In such an example, such counts may be less than counts of a maximum gallium count at an energy greater than about 8 keV and less than counts of a maximum gallium count at an energy less than about 2 keV.

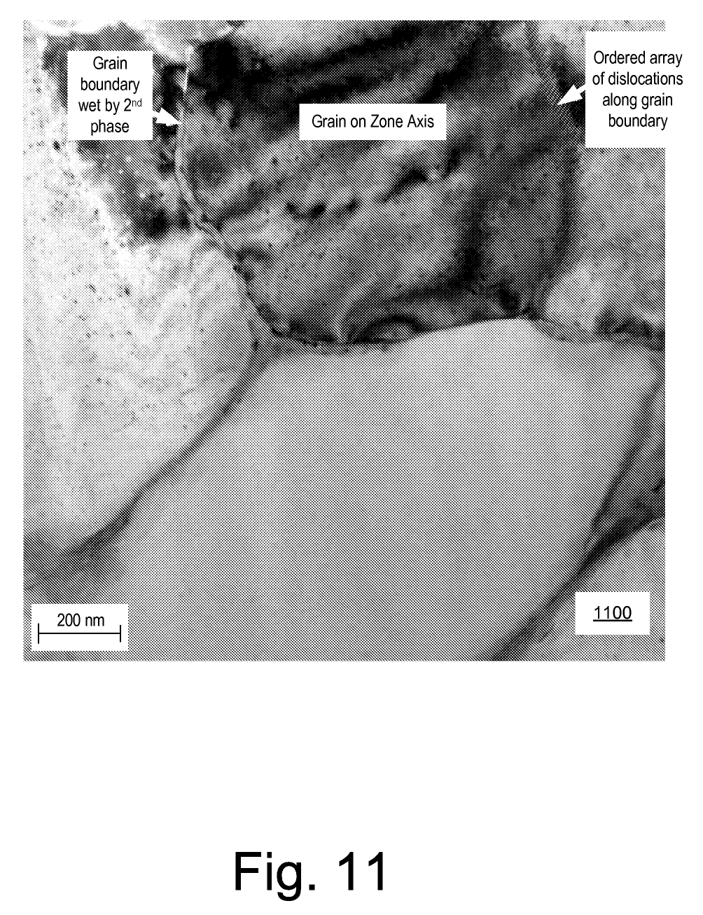

FIG. 11 shows a TEM 1100 of grains where the presence of nanocrystalline intermetallic precipitates and dispersoids may be observed in the grain interior and grain boundaries.

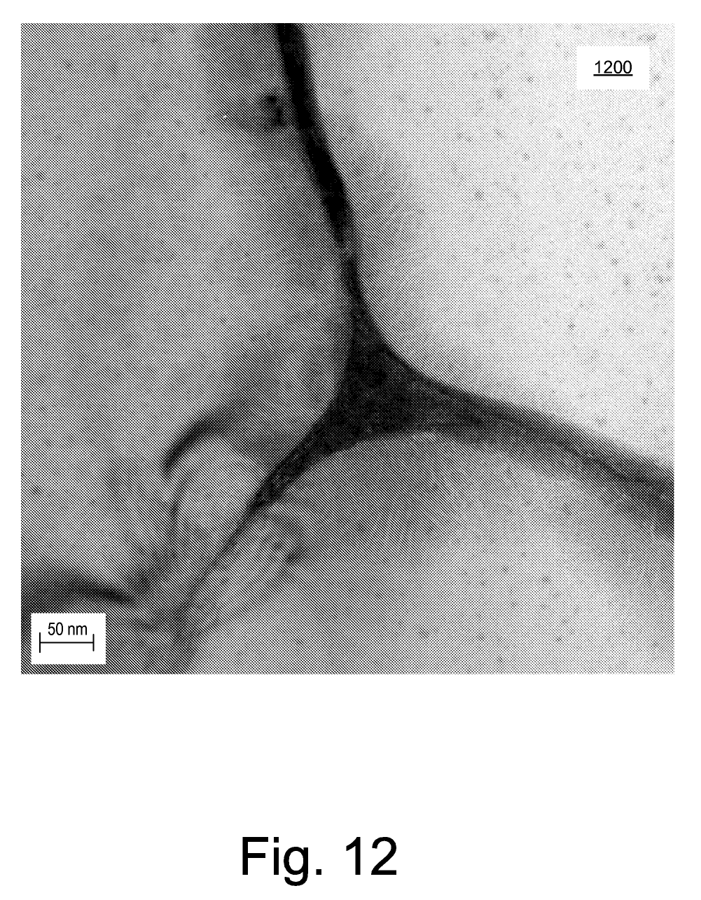

FIG. 12 shows a high-resolution TEM 1200 (e.g., HRTEM) where indicia exist as to diffusion of low melting constituents from a trapped supersaturated solid solution to a grain interior along a grain boundary. Such a phenomenon may cause liquid-metal embrittlement, which may, in turn, enhance a degradation mechanism. High-resolution transmission electron microscopy (HRTEM) is an imaging mode of a transmission electron microscope (TEM) that can allow for direct imaging of the atomic structure of a sample.

As an example, a powder may respond to dissolution and may be reactive (e.g., upon exposure to fluid, etc.). As an example, a powder may be consolidated at least in part via HIPing, for example, to produce a relatively homogeneous solid that has a desired rate of degradation (e.g., when subjected to one or more conditions). As an example, a consolidated solid may exhibit a high strength and fair ductility. As an example, degradation of powder, and hence a consolidated solid made at least in part therefrom, can be controlled by blending of one or more other powders (e.g., of one or more mesh sizes, etc.).

As an example, one or more ceramic and/or other particulates may be added to a powder (e.g., or powders) to form a metal matrix composites (MMC). In such an example, such addition(s) may achieve higher stiffness or Young's modulus and, for example, abet blunting of crack tips initiated during a fracture event. As an example, one or more consolidated solids from blended powders may yield high strength and good ductility.

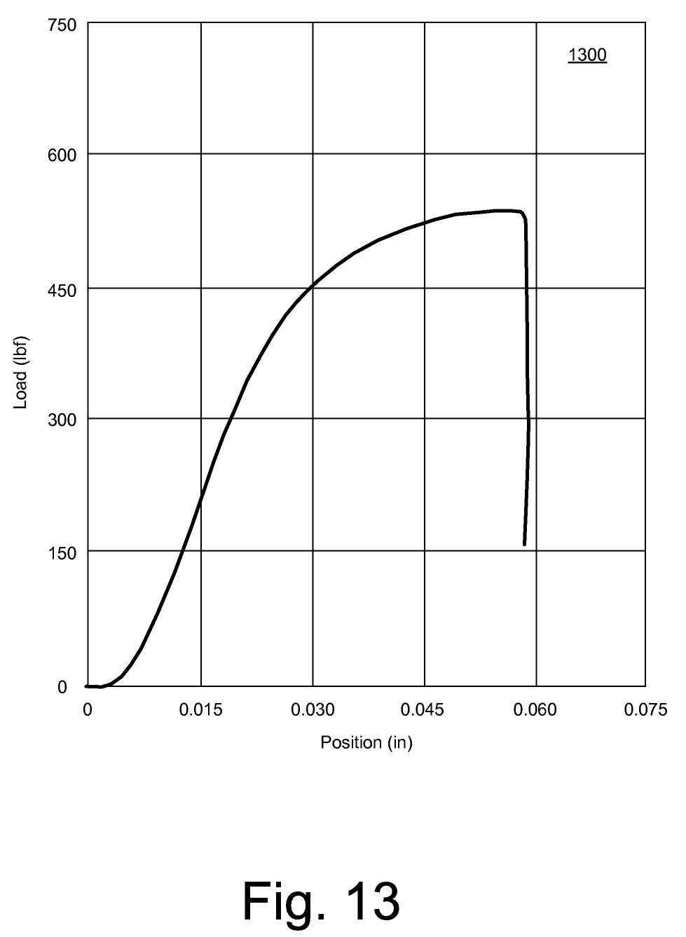

FIG. 13 shows a stress-strain plot 1300 of a consolidated solid of blended degradable alloy powders. As shown in the plot 1300, a blend may be tailored to achieve a desired stress-strain relationship (e.g., Young's modulus, etc.). In the example plot 1300, at a load of about 625 lbf or about 2800 N. Using an approximation of about 1 kgf corresponding to 10 N (e.g., Earth's gravity), a load of about 2800 N may be due to about 280 kgf (e.g., a mass of about 280 kg or about 620 lb). In the example of FIG. 13, failure occurs at a strain of about 0.060 inches (e.g., about 1.5 mm).

As an example, one or more consolidated solids, as made from one or more degradable alloy powders and/or blended powders, may respond to ageing to augment strength and one or more associated mechanical properties.

As an example, processing may alter strength, ductility or strength and ductility. The strength of a material may be defined as the material's ability to withstand an applied load without failure. Strength may characterize a material, for example, via calculations of stresses, strains, stresses and strains, etc. For example, consider predicting response of a structure under loading and its susceptibility to various failure modes, which can take into account material properties such as its yield strength, ultimate strength, Young's modulus, and Poisson's ratio. Mechanical macroscopic properties (e.g., geometric properties) such as length, width, thickness, boundary constraints, abrupt changes in geometry, etc. may be considered when determining strength of a material.

Ductility pertains to deformation under tensile stress (e.g., measurable by stretching material). Malleability pertains to deformation under compressive stress (e.g., measurable by hammering or rolling material). Ductility and malleability are mechanical properties that pertain to plasticity (e.g., extent to which a material can be plastically deformed without fracture).

An alloy can include crystalline, amorphous or mixed structure (e.g. partially crystalline, partially amorphous). Features characterizing the structure can include grains, grain boundaries, phases, inclusions, etc. As an example, one or more features may be of the order of macroscopic, micron or submicron scale, for instance nanoscale. Shape, size, shape and size, etc. may be characteristics that can influence mechanical properties and, for example, reactivity.

As an example, a reactive material may include an element that tends to form positive ions when its compounds are dissolved in a liquid solution and whose oxides form hydroxides rather than acids with water. As an example, a material may disintegrate. For example, consider an alloy that loses structural integrity and becomes dysfunctional for instance due to grain-boundary embrittlement or dissolution of one of its elements. As an example, a byproduct of degradation from grain boundaries may not necessarily include an ionic compound such as a hydroxide and may include a metallic powder residue (e.g., consider severely embrittled aluminum alloys of gallium and indium).

As an example, a material may be electrically conductive and may include a metallic luster. As an example, a material may possess a relatively high mechanical strength in tension, shear and compression (e.g., exhibit a relatively high hardness).

As an example, a material may be degradable and, for example, an alloy may be degradable (e.g., a degradable alloy). As an example, a material may degrade when subject to one or more conditions (e.g., over time). For example, consider one or more environmental conditions and/or “artificial” conditions that may be created via intervention, whether physical, chemical, electrical, etc. As an example, conditions can include temperature, pressures (e.g., including loads and forces), etc.

FIG. 14 shows an example plot 1400 of component dimension versus time of degradation for various temperatures. As indicated, degradation of a component may be determined by a physical characteristic of the component and an environmental condition such as, for example, temperature. For example, fluid at a temperature of about 120 degrees C. may cause a component to degrade more rapidly than fluid at a temperature of about 66 degrees C. As an example, a component may be constructed to include one or more layers where at least one layer includes a degradable material, which may include a dimension (e.g., thickness, etc.) that is based at least in part on information such as the information of the plot 1400 of FIG. 14.

As an example, a material may “intentionally” fail via liquid-metal embrittlement, for example, as in an alloy that includes gallium and/or indium. As an example, a degradable material may include an alloy or alloys and possess phases that may be susceptible to creep (e.g., superplastic) deformation (e.g., under intended force, etc.), possess phases that are brittle (e.g., which may rupture in response to impact, etc.).

As an example, a component may be formed of material that provides a desired degradation rate and desired mechanical properties (e.g., strength, etc.). As an example, a degradation rate may depend upon one or more conditions (e.g., temperature, pressure, fluid environments), which may be exist in an environment and/or may be achieved in an environment (e.g., via one or more types of intervention).

As an example, an environment may be a harsh environment, for example, an environment that may be classified as being a high-pressure and high-temperature environment (HPHT). A so-called HPHT environment may include pressures up to about 138 MPa (e.g., about 20,000 psi) and temperatures up to about 205 degrees C. (e.g., about 400 degrees F.), a so-called ultra-HPHT environment may include pressures up to about 241 MPa (e.g., about 35,000 psi) and temperatures up to about 260 degrees C. (e.g., about 500 degrees F.) and a so-called HPHT-hc environment may include pressures greater than about 241 MPa (e.g., about 35,000 psi) and temperatures greater than about 260 degrees C. (e.g., about 500 degrees F.). As an example, an environment may be classified based in one of the aforementioned classes based on pressure or temperature alone. As an example, an environment may have its pressure and/or temperature elevated, for example, through use of equipment, techniques, etc. For example, a SAGD operation may elevate temperature of an environment (e.g., by 100 degrees C. or more).

As an example, a degradable material may be suitable for use in an operation that may include stages. For example, consider a cementing operation, a fracturing operation, etc. As explained, a process may be associated with a completion where portions of the completion are constructed, managed, altered, etc. in one or more stages. For example, cementing may occur in stages that extend successively deeper into a drilled borehole and, for example, fracturing may occur in stages.

As an example, a method can include subjecting a material or materials to severe plastic deformation (SPD). As an example, a method can include consolidating powder via a process that includes severe plastic deforming (e.g., an SPD process or processes). As an example, a method can employ one or more metalworking techniques that involve introducing very large strains that may provide for complex stress state or high shear, resulting in a high defect density and equiaxed ultrafine grain (UFG) sizes (e.g., with a dimension less than about 500 nm or, for example, less than about 300 nm) and/or nanocrystalline (NC) structures (e.g., with a dimension less than about 100 nm).

As an example, a method can include equi-channel angular processing (ECAP). As an example, a method can include cyromilling. As an example, a method can include ECAP and cyromilling.

As an example, a material may be processed to form a degradable component or a portion of a component that is degradable. For example, a method may include processing material that includes a degradable alloy to strengthen the material. In such an example, the resulting material may be used, for example, as a component or as a portion of a component in a stage or stages of a fracturing operation. As an example, such a material may be used as a component or as a portion of a component in a tensile-loaded application, for example, consider a bridge plug, etc. As an example, a bridge plug may be a tool, for example, a bridge plug tool. Such a tool may include one or more seats, which may, for example, provide for seating of one or more plugs.

As an example, a material produced via a method that includes ECAP may be of a size that includes a cross-sectional dimension of the order of inches. For example, consider a material with a cross-sectional dimension of the order of about 10 inches or less. As an example, a material produced via a method that includes ECAP may form stock that can be machined into a spherical form, a plug form, a plug tool form, a seat form, a valve form, or other borehole tool form, etc. In such an example, the resulting component may include grains of relatively homogenous size and shape. Where the material is degradable in an environment, the degradation mechanics may be predictable via one or more models, for example, more so than a material produced without ECAP that includes a less homogeneous grain size and shape and, for example, larger grain sizes.

As an example, a method can include casting. As an example, a method can include forming a material from chips. As an example, a method can include forming a material from powder. As an example, a method can include forming a material from powder and chips. As an example, a method can include forming a near-net strengthened ball. As an example, a method can include forming a near-net strengthened dart. As an example, a method can include increasing strength of a material via processing that increases homogeneity of the material. As an example, a method can include processing that enhances degradability, for example, uniformity of degradation (e.g., CPL/PSG/WS).

As an example, a method can include reducing porosity in an alloy through severe plastic deformation (SPD). As an example, such an alloy may be a degradable alloy.

As an example, a material may be embedded with a material that is one or more of active, passive, chemical, functionalized, etc. As an example, an embedded material may alter thermal conductivity, electrical conductivity, etc. of a bulk phase of the material. As an example, an embedded material may operate at a grain boundary or grain boundaries.

As an example, a process material may be formed as part of a cable. For example, consider a power cable for an electric submersible pump. In such an example, the processed material may be armor, a strength member, a barrier, an insulator, etc.

As an example, a component formed from processed material may be a bridge plug. A bridge plug may be a downhole tool (e.g., a type of plug tool) that can be located and set to isolate a lower part of a wellbore. As an example, a bridge plug may be permanent, degradable, retrievable, etc. As an example, a bridge plug may be tailored to enable a lower wellbore to be permanently sealed from production or temporarily isolated, for example, from a treatment conducted on an upper zone.

A part, a component, etc. constructed of a processed material or processed materials may include be a fluid sampling bottle, a pressure housing, a pump shaft, a cable (e.g., wireline, a power cable, etc.), a bridge plug tool, a projectile (e.g., a drop ball, a dart, etc.), a drill stem stabilizer, etc.

As an example, a method can include making a centralizer using processed material. For example, a centralizer may exhibit enhanced wear resistance that can reduce surface damage and corrosion fatigue on a borehole assembly (e.g., BHA), for example, thereby increasing BHA lifetime. As an example, via improved abrasion wear resistance of a centralizer, reliability may be improved, for example, when drilling over extended deviated lengths.

As an example, where machining of stock material occurs, machine swarf (e.g., chips, etc.) may be processed. Swarf, also known as chips or by other process-specific names (such as turnings, filings, or shavings) may be pieces of material resulting from machining or similar subtractive (material-removing) manufacturing processes. As an example, a method can include recycling swarf. As an example, a method can include processing swarf from processed stock that is machined to form one or more components. In such an example, the processed stock may be a degradable material that is used to form one or more degradable components (e.g., parts, etc.). The swarf may be processed to form processed stock and then machined to form one or more parts. As an example, swarf may be subjected to cryomilling and/or one or more other processes.

As an example, a processed material may be machined or otherwise formed as a centralizer or as a part of a centralizer. As an example, one or more blades, one or more springs (e.g., bow springs), etc. may be formed using a processed material (e.g., processed via a severe plastic deformation process). As an example, a centralizer may be optionally formed from ECAP processed material. For example, consider a method that includes generating stock processed material with a cross-sectional dimension sufficient to machine at least a portion of a centralizer therefrom. In such an example, a bore may be machined into the stock processed material and, for example, surface protrusions may be machined (e.g., consider a hydraulic centralizer).

As an example, a plug tool may include an outer dimension (e.g., outer diameter) less than about six inches. In such an example, a part of the plug tool may be formed from ECAP processed material. For example, consider a method that includes generating stock processed material with a cross-sectional dimension sufficient to machine at least a portion of a plug tool therefrom. In such an example, a bore may be machined into the stock processed material and, for example, appropriate apertures, openings, fittings, etc. may be machined.

As an example, a borehole tool may be a tool that is part of a borehole assembly (e.g., “BHA”) or borehole system. As an example, a BHA may be a lower portion of the drillstring, including (e.g., from a bottom up in a vertical well) a bit, a bit sub, optionally a mud motor, stabilizers, a drill collar, a heavy-weight drillpipe, a jarring devices (e.g., jars) and crossovers for various threadforms. As BHA may provide force for a bit to break rock (e.g., weight on bit), survive a hostile mechanical environment and provide a driller with directional control of a borehole. As an example, an assembly may include one or more of a mud motor, directional drilling and measuring equipment, measurements-while-drilling tools, logging-while-drilling tools or other borehole tools.

As an example, a method can include producing stock material via equal-channel angular pressing and machining the stock material into at least one part. In such an example, the stock material can include an aluminum alloy. For example, consider an aluminum alloy that includes gallium.

As an example, a method may include machining stock material produced via ECAP to form at least one degradable part. As an example, a part may be a fracturing operation plug, which may optionally be a degradable fracturing operation plug. As an example, a fracturing operation plug may be a layered plug, optionally including at least one degradable layer. As an example, a fracturing operation plug may include a core and one or more layers where at least one of the layers is degradable and optionally where the core is degradable. As an example, degradable layers, a degradable core, etc. may differ in properties in a manner that effects degradability (e.g., with respect to one or more conditions). As an example, a method may include machining stock material produced via ECAP to form at least part of a borehole tool. For example, consider forming a plug tool or a portion of a plug tool such as a seat or seats of a plug tool that may be dimensioned to seat a plug or plugs.

As an example, an apparatus can include a shape and material that includes an aluminum alloy that has an average grain size less than about 1 micron or, for example, less than about 500 nanometers. In such an example, the apparatus may be a degradable apparatus. As an example, such an apparatus may be a degradable plug. In such an example, the degradable plug may include aluminum and gallium and, for example, indium.

As an example, a method can include producing stock material via equal-channel angular pressing where the stock material includes an alloy that includes an average grain size less than approximately 1 micron (e.g., or less than about 500 nanometers) and machining the stock material into at least one part of borehole tool. As an example, a borehole tool may be a tool such as, for example, a tool operable in a downhole operation. For example, consider a plug as a tool, a plug tool, a centralizer, a sampling bottle, a wireline, a slickline, etc.

As an example, an alloy may include one or more of the following group 13 elements: aluminum, gallium and indium. As an example, an alloy may include at least one of the following group 2 elements: magnesium and calcium.

As an example, a powder of particles can include an aluminum alloy where the aluminum alloy is at least approximately eighty percent by weight of the powder; and one or more metals selected from a group consisting of alkali metals, alkaline earth metals, and basic metals having an atomic number equal to or greater than 31, where the one or more metals selected from the group total at least approximately two percent by weight of the powder; where each of the particles includes individual grains formed of a grain material that includes the aluminum alloy, where each of the particles includes grain boundary material that includes the one or more metals selected from the group, and where the grain boundary material bounds the individual grains. In such an example, for each of the particles, the grain boundary material can form a continuum within which the individual grains reside. As an example, in the foregoing example, each of the particles can have a mechanical strength that is based at least in part on spacing of its individual grains by the grain boundary material.

As an example, a powder of particles can include gas atomized powder particles (e.g., a gas atomized powder).

As an example, a powder of particles can include degradable particles (e.g., at least some of the particles can be degradable particles).

As an example, a powder of particles can include particles that include indium.

As an example, a powder of particles can include particles that include gallium. In such an example, for the particles that include gallium, an energy-dispersive X-ray spectroscopy (EDX) maximum count of gallium in a grain boundary material at an energy level greater than 6 keV can exceed an EDX maximum count of gallium in a grain material at an energy level greater than 6 keV. In such an example, for the particles that include gallium, an energy-dispersive X-ray spectroscopy (EDX) maximum count of gallium in the grain boundary material at an energy level less than 6 keV can exceed an EDX maximum count of gallium in the grain boundary material at an energy level greater than 6 keV.

As an example, a powder of particles can include particles that are substantially spherical. For example, particles can be of an average sphericity greater than about 0.9.

As an example, a powder of particles may include particles that are of a crystalline structure and an amorphous structure.

As an example, a powder of particles can include particles where grains have a maximum grain dimension less than about 500 nm or, for example, less than about 200 nm. As an example, a powder of particles can include particles where grains have an average grain dimension less than about 500 nm or, for example, less than about 200 nm.

As an example, a power of particles can include particles that include ceramic material, for example, consider a ceramic material such as a metal oxide.

As an example, a powder can include an aluminum alloy where the aluminum alloy is at least approximately eighty percent by weight of the powder; one or more basic metals where each of the one or more basic metals has an atomic number equal to or greater than 31 and where the one or more basic metals total at least approximately two percent by weight of the powder; and degradable particles formed by the aluminum alloy and the one or more basic metals, where each of the degradable particles includes individual grains formed of a grain material that includes the aluminum alloy, where each of the degradable particles includes grain boundary material that includes the one or more basic metals, and where the grain boundary material bounds the individual grains. In such an example, the one or more basic metals can include gallium and/or indium. As an example, the foregoing powder may be a gas atomized powder where, for example, grains formed of the grain material have a maximum grain dimension less than about 500 nm and/or, for example, an average grain dimension less than about 500 nm.

As an example, a method can include consolidating a powder of particles into at least one part of a borehole tool where the powder of particles includes an aluminum alloy where the aluminum alloy is at least approximately eighty percent by weight of the powder; and one or more metals selected from a group consisting of alkali metals, alkaline earth metals, and basic metals having an atomic number equal to or greater than 31, where the one or more metals selected from the group total at least approximately two percent by weight of the powder; where each of the particles includes individual grains formed of a grain material that includes the aluminum alloy, where each of the particles include grain boundary material that includes the one or more metals selected from the group, and where the grain boundary material bounds the individual grains. In such an example, consolidating can include severe plastic deforming (e.g., performing one or more processes that apply severe plastic deformation).

As an example, a degradable apparatus can include a shaped material that includes an aluminum alloy where the aluminum alloy is at least approximately eighty percent by weight of the shaped material; one or more metals selected from a group consisting of alkali metals, alkaline earth metals, and basic metals having an atomic number equal to or greater than 31, where the one or more metals selected from the group total at least approximately two percent by weight of the shaped material; individual grains of a grain material that include the aluminum alloy; and grain boundary material that includes the one or more metals of the group where the grain boundary material bounds the individual grains. In such an example, the individual grains can be of an average grain dimension less than about 500 nm.

As an example, one or more methods described herein may include associated computer-readable storage media (CRM) blocks. Such blocks can include instructions suitable for execution by one or more processors (or cores) to instruct a computing device or system to perform one or more actions. As an example, equipment may include a processor (e.g., a microcontroller, etc.) and memory as a storage device for storing processor-executable instructions. In such an example, execution of the instructions may, in part, cause the equipment to perform one or more actions (e.g., consider a controller to control processing such as ECAP, cryomilling, machining, forming, cementing, fracturing, etc.). As an example, a computer-readable storage medium may be non-transitory and not a carrier wave.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

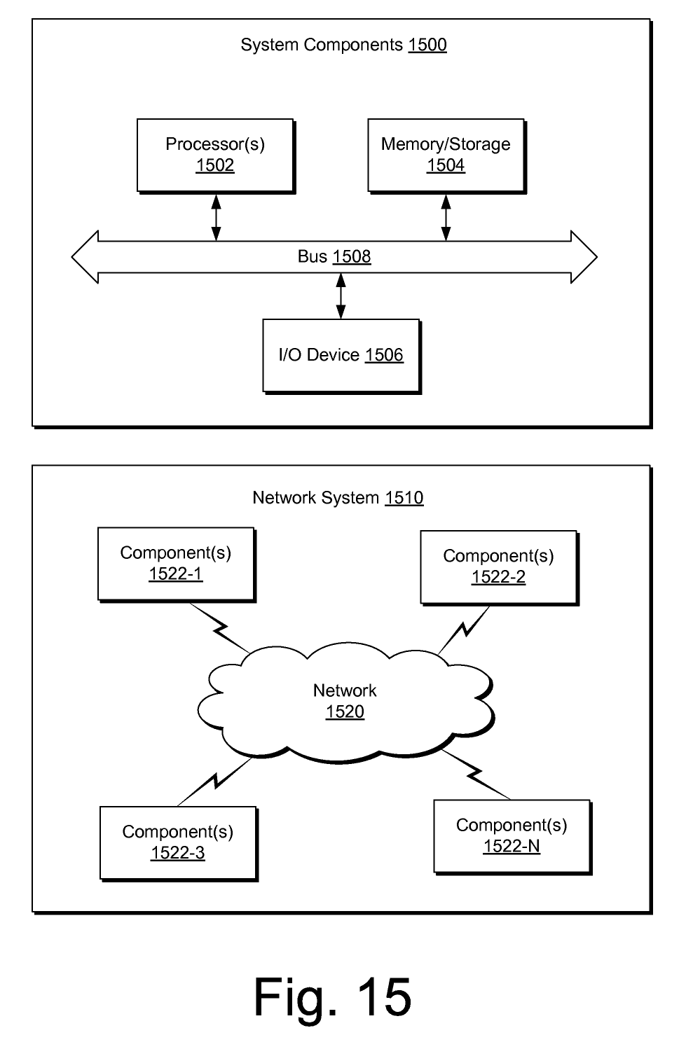

FIG. 15 shows components of a computing system 1500 and a networked system 1510. The system 1500 includes one or more processors 1502, memory and/or storage components 1504, one or more input and/or output devices 1506 and a bus 1508. According to an embodiment, instructions may be stored in one or more computer-readable media (e.g., memory/storage components 1504). Such instructions may be read by one or more processors (e.g., the processor(s) 1502) via a communication bus (e.g., the bus 1508), which may be wired or wireless. As an example, instructions may be stored as one or more modules. As an example, one or more processors may execute instructions to implement (wholly or in part) one or more attributes (e.g., as part of a method). A user may view output from and interact with a process via an I/O device (e.g., the device 1506). According to an embodiment, a computer-readable medium may be a storage component such as a physical memory storage device, for example, a chip, a chip on a package, a memory card, etc.

According to an embodiment, components may be distributed, such as in the network system 1510. The network system 1510 includes components 1522-1, 1522-2, 1522-3, . . . 1522-N. For example, the components 1522-1 may include the processor(s) 1802 while the component(s) 1522-3 may include memory accessible by the processor(s) 1502. Further, the component(s) 1502-2 may include an I/O device for display and optionally interaction with a method. The network may be or include the Internet, an intranet, a cellular network, a satellite network, etc.

### CONCLUSION

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A powder of particles comprising:
an aluminum alloy wherein the aluminum alloy is at least approximately eighty percent by weight of the powder; and
one or more metals selected from a group consisting of alkali metals, alkaline earth metals, and basic metals having an atomic number equal to or greater than 31, wherein the one or more metals selected from the group total at least approximately two percent by weight of the powder;
wherein each of the particles comprises individual grains formed of a grain material that comprises the aluminum alloy,
wherein each of the particles comprises grain boundary material that comprises the one or more metals selected from the group, and
wherein the grain boundary material bounds the individual grains.

2. The powder of particles of claim 1 wherein, for each of the particles, the grain boundary material forms a continuum within which the individual grains reside.

3. The powder of particles of claim 1 wherein each of the particles comprises a mechanical strength that is based at least in part on spacing of its individual grains by the grain boundary material.

4. The powder of particles of claim 1 comprising a gas atomized powder.

5. The powder of particles of claim 1 wherein the particles comprise degradable particles.

6. The powder of particles of claim 1 wherein the one or more metals comprise indium.

7. The powder of particles of claim 1 wherein the one or more metals comprise gallium.

8. The powder of particles of claim 7 wherein an energy-dispersive X-ray spectroscopy (EDX) maximum count of gallium in the grain boundary material at an energy level greater than 6 keV exceeds an EDX maximum count of gallium in the grain material at an energy level greater than 6 keV.

9. The powder of particles of claim 8 wherein an energy-dispersive X-ray spectroscopy (EDX) maximum count of gallium in the grain boundary material at an energy level less than 6 keV exceeds an EDX maximum count of gallium in the grain boundary material at an energy level greater than 6 keV.

10. The powder of particles of claim 1 wherein the particles are substantially spherical.

11. The powder of particles of claim 1 wherein the particles comprise an average sphericity greater than about 0.9.

12. The powder of particles of claim 1 wherein the particles comprise crystalline structure and amorphous structure.

13. The powder of particles of claim 1 wherein grains formed of the grain material comprise a maximum grain dimension less than about 500 nm.

14. The powder of particles of claim 1 wherein grains of the grain material comprise a maximum grain dimension less than about 200 nm.

15. The powder of particles of claim 1 wherein at least a portion of the particles comprises ceramic material.

16. The powder of particles of claim 15 wherein the ceramic material comprises a metal oxide.

17. A powder comprising:
an aluminum alloy wherein the aluminum alloy is at least approximately eighty percent by weight of the powder;
one or more basic metals wherein each of the one or more basic metals has an atomic number equal to or greater than 31 and wherein the one or more basic metals total at least approximately two percent by weight of the powder; and
degradable particles formed by the aluminum alloy and the one or more basic metals,
wherein each of the degradable particles comprises individual grains formed of a grain material that comprises the aluminum alloy,
wherein each of the degradable particles comprises grain boundary material that comprises the one or more basic metals, and
wherein the grain boundary material bounds the individual grains.

18. The powder of claim 17 wherein the one or more basic metals comprises gallium.

19. The powder of claim 18 wherein the one or more basic metals comprises indium.

20. The powder of claim 17 comprising a gas atomized powder.

21. The powder of claim 17 wherein grains formed of the grain material comprise a maximum grain dimension less than about 500 nm.

22. A method comprising:
consolidating a powder of particles into at least one part of a borehole tool wherein the powder of particles comprises
an aluminum alloy wherein the aluminum alloy is at least approximately eighty percent by weight of the powder; and
one or more metals selected from a group consisting of alkali metals, alkaline earth metals, and basic metals having an atomic number equal to or greater than 31, wherein the one or more metals selected from the group total at least approximately two percent by weight of the powder;
wherein each of the particles comprises individual grains formed of a grain material that comprises the aluminum alloy,
wherein each of the particles comprises grain boundary material that comprises the one or more metals selected from the group, and
wherein the grain boundary material bounds the individual grains.

23. The method of claim 22 wherein the consolidating comprises severe plastic deforming.

24. A degradable apparatus comprising:
a shaped material that comprises
an aluminum alloy wherein the aluminum alloy is at least approximately eighty percent by weight of the shaped material;
one or more metals selected from a group consisting of alkali metals, alkaline earth metals, and basic metals having an atomic number equal to or greater than 31, wherein the one or more metals selected from the group total at least approximately two percent by weight of the shaped material;
individual grains of a grain material that comprises the aluminum alloy; and
grain boundary material that comprises the one or more metals of the group wherein the grain boundary material bounds the individual grains.

25. The degradable apparatus of claim 24 wherein the individual grains comprise an average grain dimension less than about 500 nm.
